(19) United States
(12) Patent Application Publication
(10) Pub. No.: US 2015/0052028 A1
(43) Pub. Date: Feb. 19, 2015

(54) Systems and Methods for Recommending Providers and for Processing Product Inventories of Providers

(71) Applicant: IPPSYS LLC, Madisonville, LA (US)

(72) Inventors: David Thomas Wooden, Somerville, MA (US); Cameron Thomas Cantrelle, Madisonville, LA (US)

(73) Assignee: IPPSYS LLC, Madisonville, LA (US)

(21) Appl. No.: 13/967,876

(22) Filed: Aug. 15, 2013

(51) Int. Cl. G06Q 10/08

(52) U.S. Cl. CPC G06Q 10/087
USPC 705/28

(57) ABSTRACT

A system for processing an inventory of plants of a provider is disclosed. The system may include an inventory processor, which matches the plant in the inventory to a plant in a master list of plants. The processor may identify an inventory label of the inventory plant and a candidate genus based on the inventory label. The processor may determine candidate plants from the master list based on the candidate genus, and score each master label associated with the candidate plants with a master score, by determining a first score for the master label, based on a count of letters in the inventory label, and a second score. The processor may select a minimum of the first score and the second score as the master score; select a plant having a highest master score as a matched plant; and create a database record associating the matched plant with the provider.

### BACKGROUND

Plant consumers, such as commercial landscapers and gardeners often need a variety of landscaping materials, including plants, in various quantities to accomplish their jobs. Plant consumers can source their plants from various providers, such as plant nurseries, according to their needs and the providers' availabilities, Currently, plant consumers place orders for the products they need using a process of contacting several providers, to inquire about their respective inventories and sourcing availability, and making decisions based on various guidelines or requirements, including budget, pickup and delivery options, preferred sources, and/or the maximum number of different providers they prefer to deal with,

The number of providers that an end consumer, such as a plant consumer, may need to consider to fulfill their orders can be in the tens, hundreds, or thousands. Inventories of the providers can be stored in a database to facilitate the end consumer's ability to access and sort through the large number of inventories. In some cases, the providers are not equipped and/or inclined to format their inventories for the purpose of entry in a database. For example, many plant nurseries may disseminate traditional paper inventories that list their available items in different text and line formats, or with equivalent but different data content (such as different names for the same plant). In another example, some plant nurseries may be able to provide their inventories in standardized formats and fields, but still use different names to indicate the same plants. However, data that. Is not standardized cannot be compared against each other, as needed by the end consumer. Disclosed systems and methods are directed to improved processing of disparate data, to enable an improved marketplace for consumers and providers.

### SUMMARY

In one aspect, the present disclosure is directed to a computer system for processing an inventory of plants of a provider into a database. The system may include an input interface, which receives the inventory, wherein one or more plants in the inventory are associated with an inventory label. The system may also Include a storage device, which stores a master list of plants, wherein each plant in the master list is associated with a master label. The system, may further include an inventory processor, implemented by one or more computing processors, which matches a selected plant in the inventory to a plant in the master list. The inventory processor may match the selected plant in the inventory to the plant in the master list by identifying the inventory label of the selected plant. The inventory processor may also identify at least one candidate genus based on the inventory label of the selected plant. The inventory processor may further determine candidate plants by identifying plants in the master list that are associated with the at least one candidate genus. The inventory processor may also score master labels of the candidate plants with master scores. The scoring of each master label may include determining a first score for the master label based on a count of letters in the inventory label. The scoring may also include determining a second score for the master label. The scoring may further include selecting a minimum of the first score and the second score as the master score. The scoring may also include selecting a plant having a highest master score front the candidate plants as a matched plant. The inventory processor may also create a record in the database associating the matched plant with the provider.

In another aspect, the present disclosure is directed to a computer system for determining recommended providers for an order of plants. The system may include an order input interface, which receives the order including parameters related to the order. The system may also include a database, which stores a set of candidate providers and corresponding inventories of plants of the candidate providers. The system may further include an inventory system., which processes an inventory of plants of a provider into the database using the methods and systems disclosed herein, for example. In addition, the system may include a solver, such as a linear programming solver, for choosing the recommended providers from the set of candidate providers based on the parameters included in the order of the candidate providers.

In yet another aspect, the present disclosure is directed to a computer-implemented method for processing an inventory of a provider into a database, performed by one or more computing processors. The method may include receiving the inventory, wherein one or more plants in the inventory are associated with an inventory label. The method may also include storing, in a storage device, a master list of plants, wherein each plant in the master list is associated with a master label. The method may further include matching, by the one or more computing processors, a selected plant in the inventory to a plant in the master list. The matching may include identifying the inventory label of the selected plant, and identifying at least one candidate genus based on the inventory label of the selected plant. The matching may also include determining candidate plants by identifying plants in the master list that are associated with the identified germs. The matching may further include scoring each master label of the candidate plants with a master score. The scoring may include determining a first score for the master label, based on a count of letters in the inventory label, and a second score for the master label. The matching may also include selecting a minimum of the first score and the second score as the master score. The scoring may further include selecting a plant having a highest master score from the candidate plants as a matched plant. The method for processing the inventory may further include creating a record in the database associating the matched plant with the provider.

In a further aspect, the present disclosure is directed to a computer system for processing an inventory of products of a provider into a database. The system may include an input interface, which receives the inventory, wherein one or more products in the inventory are associated with an inventory label The system may also include a storage device, which stores a master list of products, wherein each product in the master list is associated with a master label. The system may further include an inventory processor, implemented by one or more computing processors, which matches a selected product in the inventory to a product in the master list. The inventory processor may match the selected product in the inventory to the product in the master list by identifying the inventory label of the selected product. The inventory processor may also identify at least one candidate class based on the inventory label of the selected product. The inventory processor may further determine candidate products by identifying products in the master list that are associated with the at least one candidate class. The inventory processor may also score master labels of the candidate products with master scores. The scoring of each master label may include determining a first score for the master label based on a count of letters in the inventory label. The scoring may also include determining a second score for the master label. The scoring may further include selecting a minimum of the first score and the second score as the master score. The scoring may also include selecting a product having a highest master score from the candidate products as a matched product. The inventory processor may aiso create a record in the database associating the matched product with the provider.

In another aspect, the present disclosure is directed to a computer method for processing an inventory of a provider into a database, performed by one or more computer processors. The method may include matching, by the one or more computing processors, a selected product in the inventory to a product in the master list, wherein the selected product in the inventory is associated with an inventory label. The matching may include identifying at least one candidate class based on the inventory label. The matching may also include identifying candidate products associated with respective master labels from the master list, the candidate products being in the at least one candidate class. The matching may further include scoring one or more master labels of the candidate products by comparing the one or more master labels with the inventory label. The method may also include selecting a product from the candidate products having the highest score as a matched product. The method for processing the inventory may further include creating a record in the database associating the matched product with the provider.

In another aspect, the present disclosure is directed to a computer method for processing an inventory of a provider into a database, performed by one or more computer processors. The method may include matching, by the one or more computing processors, a selected plant in the inventory to a plant in the master list, wherein the selected plant in the inventory is associated with an inventory label. The matching may include identifying at least one candidate class based on the inventory label. The matching may also include identifying candidate plants associated with respective master labels from the master list, the candidate plants being in the at least one candidate class. The matching may further include scoring one or more master labels of the candidate plants by comparing the one or more master labels with the inventory label. The method may also include selecting a plant from the candidate plants having the highest score as a matched plant. The method for processing the inventory may further include creating a record in the database associating the matched plant with the provider.

In yet another aspect, the present disclosure is directed to a computer system for processing an inventory of a provider into a database. The system may include an input interface, which receives the inventory, wherein one or more plants in the inventory are associated with an inventory label. The system may also include a storage device, which stores a master list of plants, wherein each plant in the master list is associated with a master label. The system may further include an inventory processor, implemented by one or more computing processors, which matches a selected plant in the inventory to a plant in the master list. The matching may include identifying the inventory label of the selected plant, and identifying at least one candidate genus based on the inventory label of the selected plant. The matching may also include identifying candidate plants associated with respective master labels from the master list, the candidate plants being in the at least one candidate genus. The matching may further include scoring one or more master labels of the candidate plants by comparing the one or more master labels with the inventory label. The matching may also include selecting a plant from the candidate plants having the highest score as a matched plant. The inventory processor may also create a record in the database associating the matched plant with the provider.

It is understood that both, the foregoing general description and the following detailed description, are exemplary and explanatory only and are not restrictive of the embodiments of the invention, as claimed. The description of aspects, features and/or advantages of particular embodiments should not be construed as limiting other embodiments or the claims.

### BRIEF DESCRIPTION OF THE DRAWINGS

FIG. 1A depicts an exemplary product ordering system and an exemplary provider recommendation system;

FIG. 1B depicts an exemplary website user interface of the provider recommendation system;

FIG. 1C depicts an exemplary website user interface of the provider recommendation system:

FIG. 2 depicts a block diagram of an exemplary inventory system;

FIG. 3 an exemplary method of processing an inventory by an inventory system:

FIG. 4 depicts an exemplary method of processing a plant inventory by an inventory system;

FIG. 5A depicts a portion of an exemplary plant inventory;

FIG. 5B depicts a portion of an exemplary master list;

FIG. 5C depicts a portion of another exemplary master list;

FIG. 6 depicts an exemplary method of parsing an inventory by an inventory system;

FIG. 7 depicts an exemplary method of identifying a candidate genus by an inventory system:

FIG. 8A depicts an exemplary method of identifying candidate plants by an inventory system;

FIG. 8B depicts another exemplary method of identifying candidate plants by an inventory system;

FIG. 9 depicts an exemplary method of scoring candidate plants and identifying a matching candidate plant by an inventory system;

FIG. 10 depicts an exemplary method of determining a first score for a candidate plant by an inventory system: and

FIG. 11 depicts an exemplary method of determining a second score for a candidate plant by an inventory system,

### DETAILED DESCRIPTION

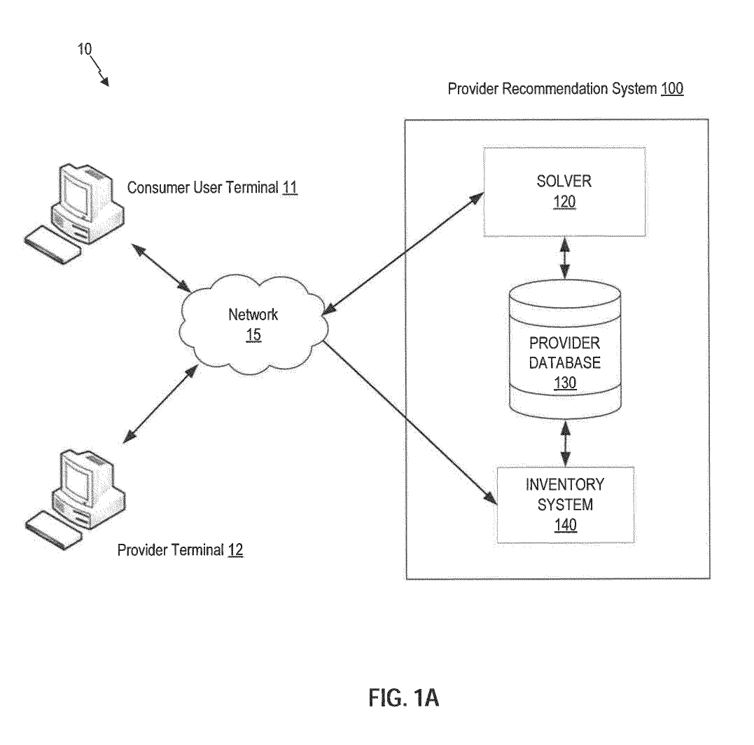

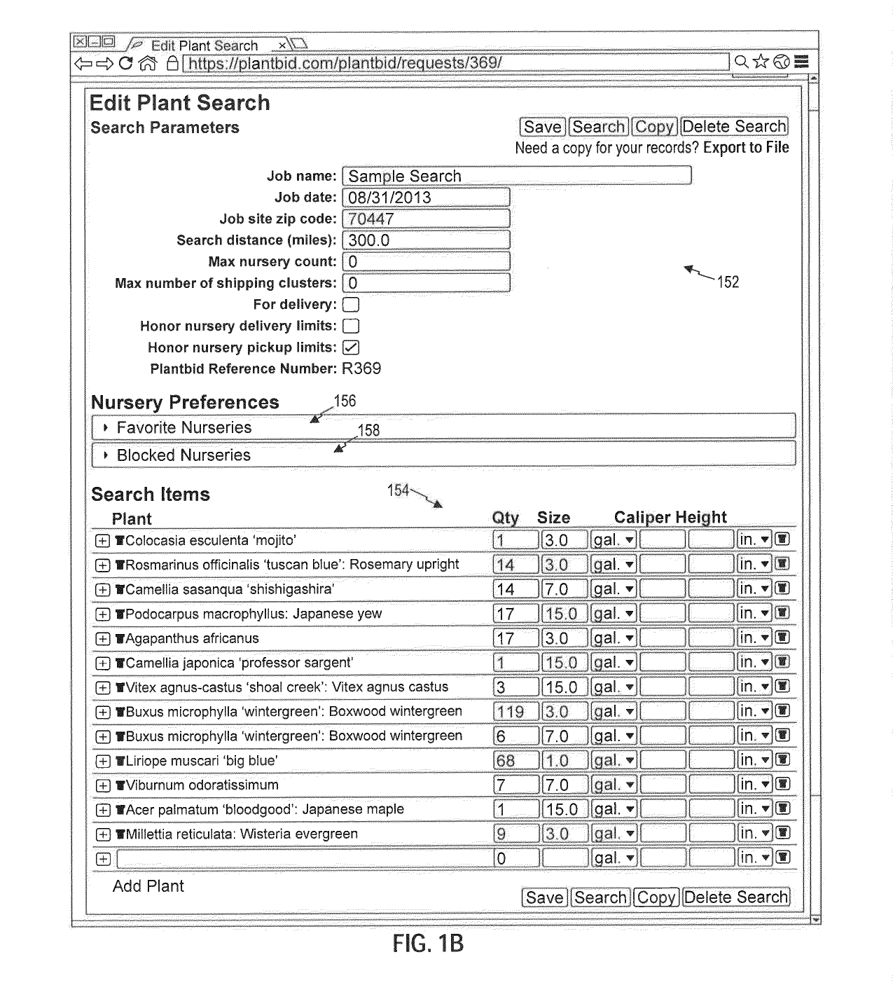

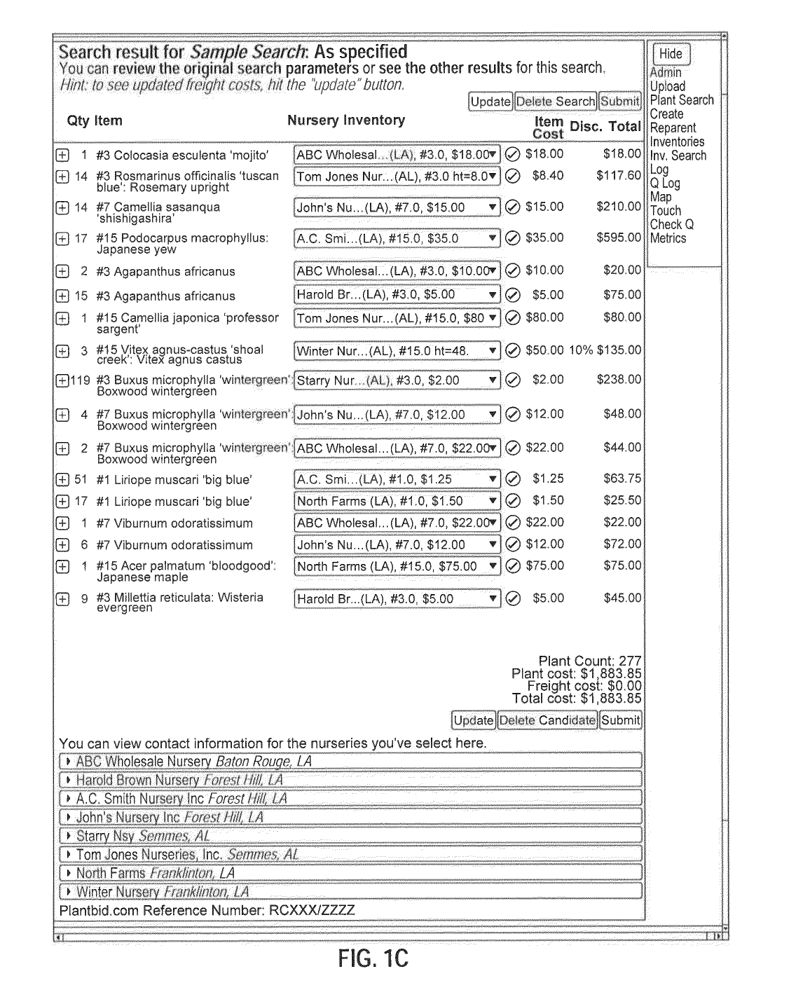

FIG. 1A illustrates an exemplary embodiment of a product ordering system 10. Product ordering system 10 may include a consumer terminal 11, a provider terminal 12, and a provider recommendation system 100, connected via a network 15. In one embodiment, consumer terminal 11, provider terminal 12, and/or provider recommendation system 100 may be computer systems. Computer systems may include a standalone computer such as a PC or a laptop, a mobile phone such as a smartphone, or include multiple computers connected as a network. Network 15 may generally include any wired and/or wireless network, or combinations thereof. Network 15 may include an intranet and/or the internet.

Provider recommendation system 100 may receive an order as input from a consumer user via consumer terminal 11. Provider recommendation system 100 may include a solver 120, a provider database 130, and an inventory system 140 to process the order and generate one or more recommended providers for fulfilling the order. Provider recommendation system 100 may receive the order via an order input interface. The order input interface may be any interface for receiving an order from a consumer user. For example, an exemplary order input interface 110 may comprise a website that is presented on consumer terminal 11 (e.g., as shown in FIG. 1B). The consumer user may enter or upload their order via the website, and then the order may be sent to the solver 120 via network 15. The order may include one or more desired products, and may also include product specifications associated with the desired products, e.g., quantity, size, color, style, form, and/or other product specifications. The order may also include order specifications, e.g., delivery options, maximum number of providers to fill the order, maximum cost, preferred providers (specific by name, location, rating, and/or other parameters), and/or other specifications.

Solver 120, which may receive the order from the order input interface, may determine a set of one or more recommended providers from which to order the desired products. Solver 120 may be implemented by one or more computing processors. For example, solver 120 may be implemented by one or more computing processors executing instructions of a software program stored on one or more storage devices such as volatile, non-volatile, magnetic, semiconductor, tape, optical, removable, non-removable, and/or other types of computer-readable medium. Further examples of such types of computer-readable medium include RAM, DRAM, USB, and CD-ROM. In an exemplary embodiment, solver 120 may be a linear programming solver, which solves for a set of one or more recommended providers by optimizing for one or more specifications of the order, e.g., product specifications, order specifications, etc. Such optimization may optimize, for example, the percentage of the order that can be fulfilled, the total cost of fulfilling the order, etc. Solver 120 may output the recommended providers via a recommendation output interface (e.g., as shown in FIG. 1C). Similar to the order input interface, the output interface may comprise a website presented on a user terminal or one or more messages sent to a user, for example, email messages. Solver 120 may output the recommended providers via network 15.

Solver 120 may determine the recommended providers based on information stored in a provider database 130. Provider database 130 may be implemented on one or more data storage media and may include records of various providers and their respective associated inventory. That is, provider database 130 may include information associated with a provider and the products the provider has available for sale, along with product specifications and provider details, such as available delivery options, bulk discounts, and/or other provider information.

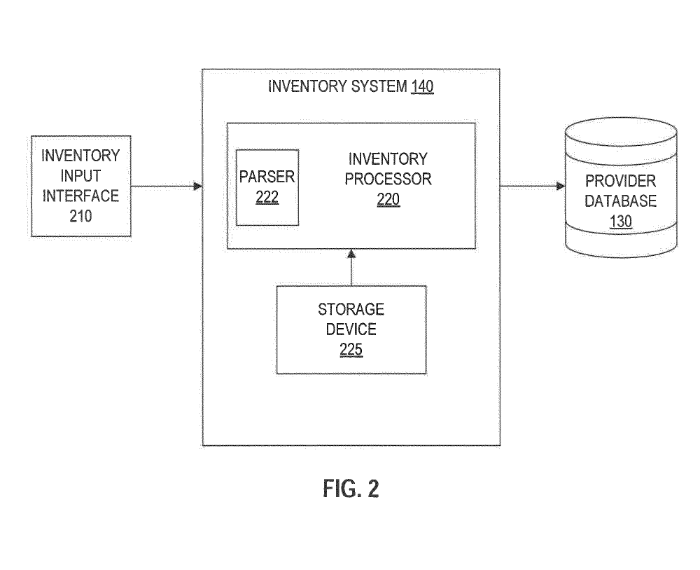

Inventory system 140 may populate and update provider database 130 based on the inventories of the providers. Inventory system 140 may be implemented by one or more computing processors, as similarly described above with respect to solver 120. For example, inventory system 140 may be implemented by one or more computing processors executing instructions of a program stored on one or more computer-readable media. As recognizable to one of ordinary skill in the art, solver 120 and inventory system 140 may be implemented by the same processor or different processors. Furthermore, solver 120 and inventory system 140 may be implemented on the same physical device, or on separate physical devices that are connected by communication busses and/or wired/wireless networks such as network 15. Inventory system 140 may receive the provider's inventories via an inventory input interface (shown in FIG. 2) in any format, for example, as a text file, a PDF file, a spreadsheet file, a facsimile, and/or other known data and document formats, or as information entered into fields in a web-based form. Further details of inventory system 140 will be described below, with respect to FIG. 2.

In one embodiment, provider recommendation system 100 may be a system that recommends plant providers, e.g., plant nurseries, etc., based on plant orders from plant consumers, e.g., landseapers, gardeners, rewholesalers, etc. In such embodiments, the product order may include a listing of plants desired by the plant consumer and include plant specifications such as, for example, name, color, type of pot, size of pot, size of plant, variety of a plant characteristics, quantity, and/or other specifications. To generate provider recommendations, solver 120 may perform a matching process of the various plant specifications of the order with plant details in the inventory records of provider database 130. For example, solver 120 may identify the name of a plant desired by the plant consumer and identify the providers that have plants matching that name in their inventories, as stored in provider database 130. In another example, solver 120 may also identify plants that are similar to and/or close estimates of the desired plant indicated in the order.

FIG. 1B depicts a screenshot of a website user Interface as part of an exemplary order input interface. The website may include input fields 152 for order specifications and input fields 154 for product specifications. The website may also include options 156 and 158 for indicating preferred product providers and unwanted product providers. A consumer user may input values into some of these fields based on a product order that the consumer user wishes to fulfill The Inputted information may be transmitted to provider recommendation system 100 and processed by solver 120. Provider recommendation system 100 may output recommended product providers based on the processing by solver 120.

FIG. 1C depicts a screenshot of a website user interface with exemplary output of recommended product providers by provider recommendation system 100. The output includes recommendations of which nurseries to source products, and the quantities of the products to be sourced from the nurseries, based on the order input into the website in FIG. 1B and the availability of the products in the inventory of the providers as stored in provider database 130. The output may also include other information, such as the total cost, discounted prices, freight costs, etc.

In some situations, for solver 120 to be able to provide useful provider recommendations from provider database 130, provider database 130 may need to include a large number of providers. An exemplary provider database 130 may store, for example, on the order of hundreds or thousands of providers. As providers may refer to items and/or format the items in their inventories inconsistently, whether within a provider's own inventory or across inventories of different providers, the inventory of each provider may need to be standardized, prior to creating a record of the inventory in provider database 130. Alternatively, consistency may be achieved by modifying data records In provider database 130 after importing a provider's inventory. The methods and systems disclosed herein may be implemented prior to record creation, or following record creation, supplanting the original inconsistent record with a consistent record.

A distinct variety of a plant would preferably be identified by the same name or identifier in provider database 130, despite that the single variety of plant may be called by many different names by providers. As an example, a particular variety of holly can be referred to as ilex cassine, Dahoon Holly, or Cassena. To be able to make comparisons between multiple plant providers that have this variety of holly available in their respective inventories, database records should reflect the same name identifier for the particular holly variety. In one embodiment, inventory system 140 may create an association between plant providers and this type of holly in provider database 130 by using the name ilex cassine, regardless of whether the inventories received from each plant provider identified the plant using a different name, such as Dahoon Holly or Cassena. The systems and methods disclosed herein may be particularly useful when inventories are updated frequently, when the inventories of individual providers are large, and/or when provider database 130 is populated with records for many providers.

FIG. 2 illustrates a block diagram of an exemplary inventory system 140, which processes inventories of providers. Inventory system 140 may include an inventory processor 220 and a storage device 225. Inventory processor 220 may receive an inventory from a provider via inventory input interface 210, process the inventory, and output one or more records to be stored in provider database 130 associating the provider with its available products. In one embodiment, inventory processor 220 may include a parser 222, which parses the inventory to facilitate the processing and generation of a record by inventory processor 220. Storage device 225 may store information that is used by inventory processor 220 to process the inventory, and may be any type of computer-readable medium. Inventory processor 220 and parser 222 may be implemented as software programs.

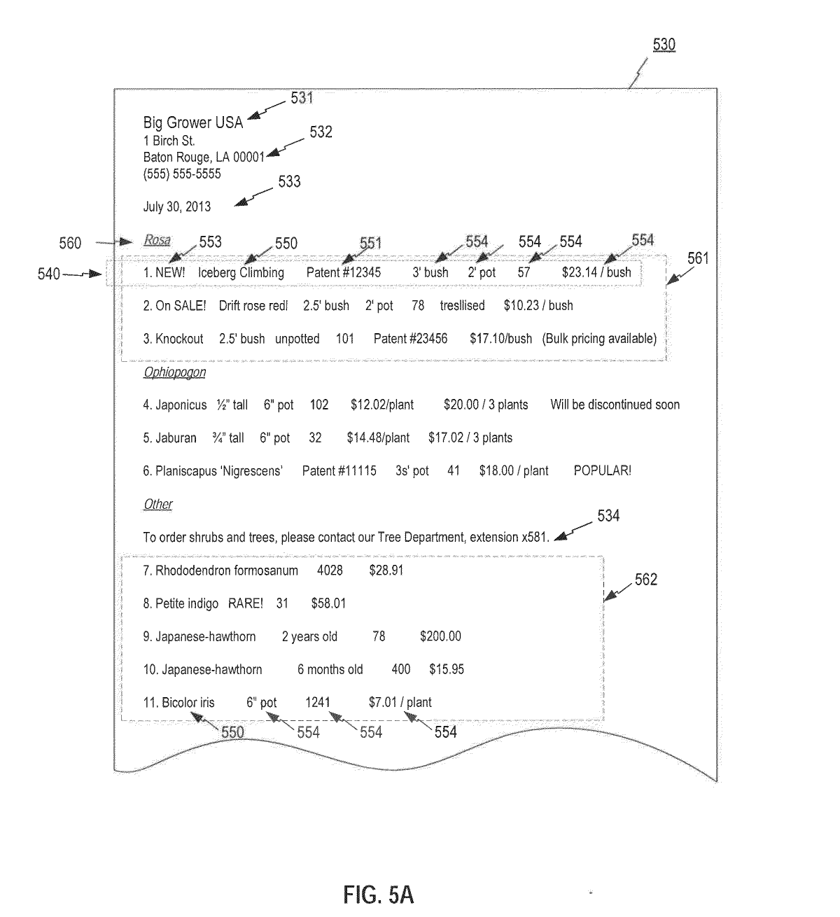

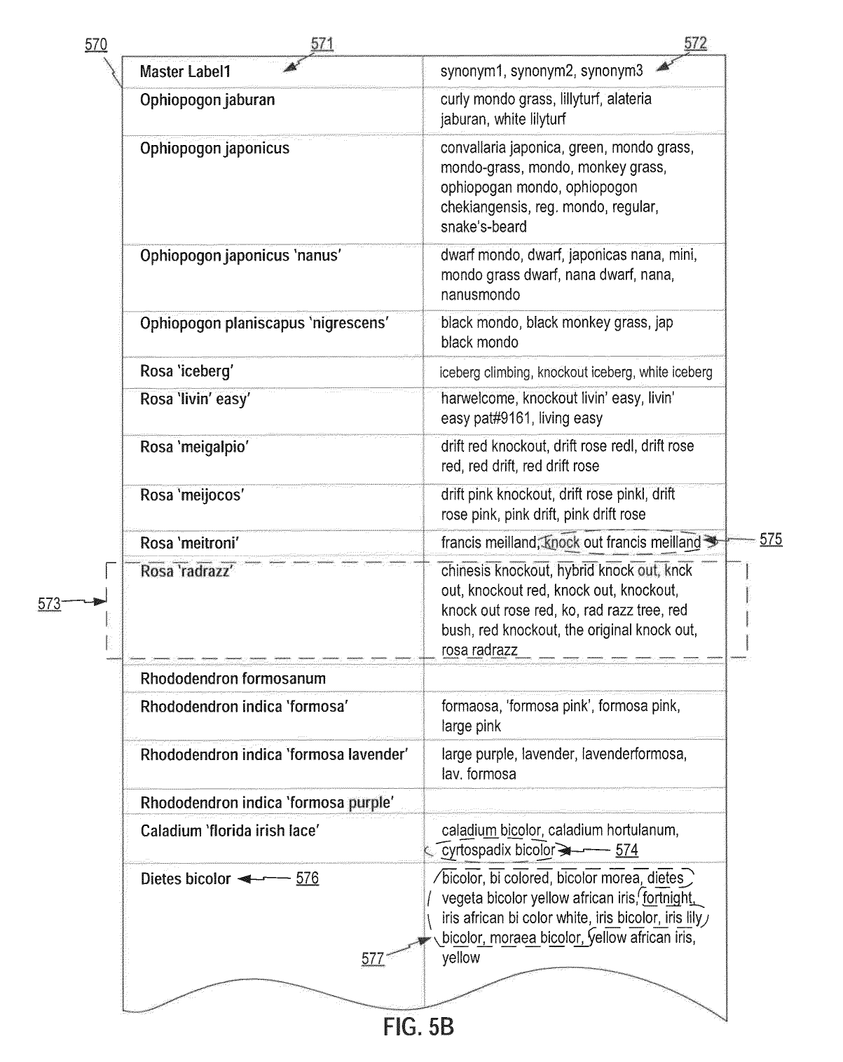

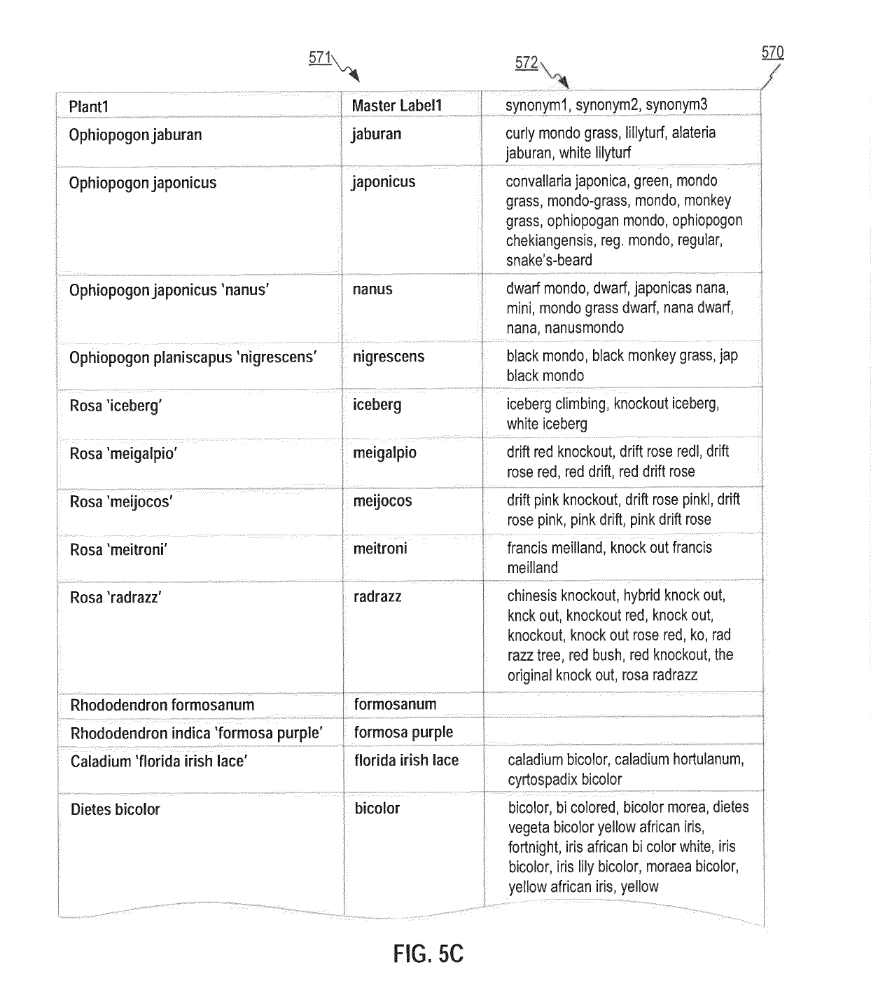

An inventory received from inventory input interface 210 may include an inventory label for identifying a product (e.g., a product, name). For the same product in inventories of different providers, the inventory label may not be the same. Also, the same product may be identified by different inventory labels within the inventory of one provider, or between inventories of the same provider generated at different, times. For example, the product may be commonly known by several different names, and different providers may choose to use different ones of those names to identify their product. As another example, the product may be identified by a name that is similar to the commonly known names, but slightly modified for various, idiosyncratic reasons that are provider-specific, including spelling mistakes. As a further example, one provider may use the full name of the product while another provider may use an abbreviated name of the product. For inventory processor 220 to identify the plant that is named in the inventory and to create and store a record that allows for common identification schemes and efficient searching in provider database 130, inventory processor 220 may utilize a master list stored in storage device 225. The master list is a list of distinct products, each identified by a master label. For a distinct product, the master list may also include a list of synonyms corresponding to the product and the master label. Exemplary inventories and master lists are described below with respect to FIGS. 5A, 5B, and 5C.

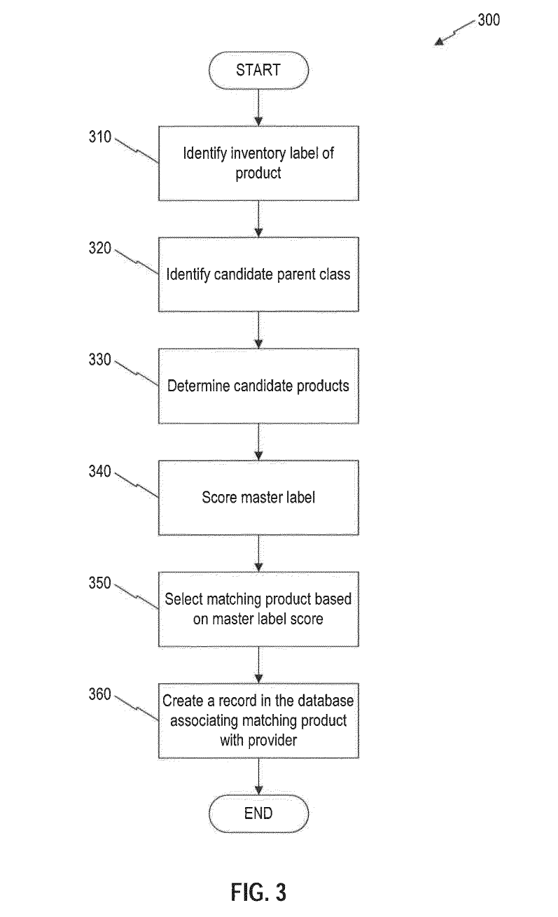

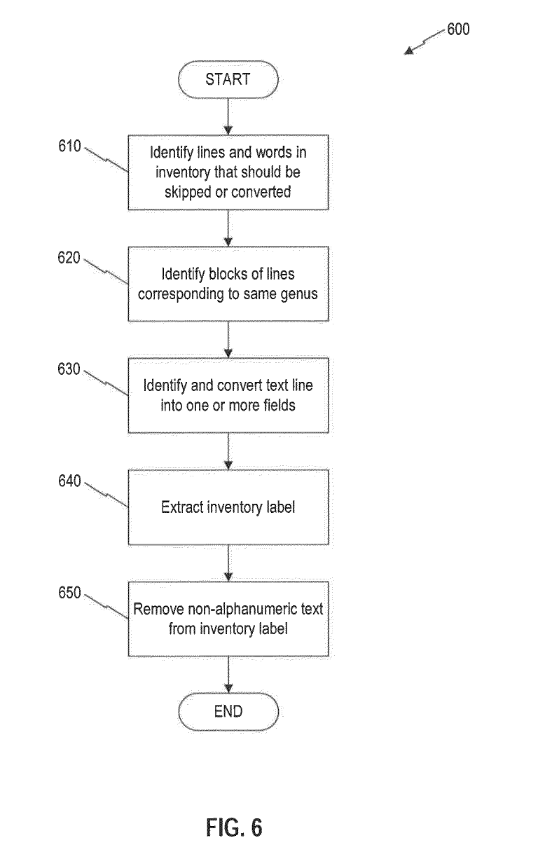

An exemplary method 300 by which inventory processor 220 processes an inventory of a provider is shown in FIG. 3. After receiving a provider's inventory, inventory processor 220 may identify an inventory label corresponding to an inventory product, at step 310. Such identification may, in some embodiments, be based on a pre-known format of inventories associated with the particular provider, as will be described in more detail with respect to FIG. 6 based on a plant inventory example. Information about the format configuration may be input into inventory system 140, by a backend support technician, for example, before the first inventory of the particular provider is processed by inventory processor 220. It may then be assumed that subsequent inventories of the particular provider follow the same format configuration. In another embodiment, inventory processor 220 may be able to automatically determine the format of the inventory, based on comparisons to known format configurations or using pattern recognition algorithms, for example.

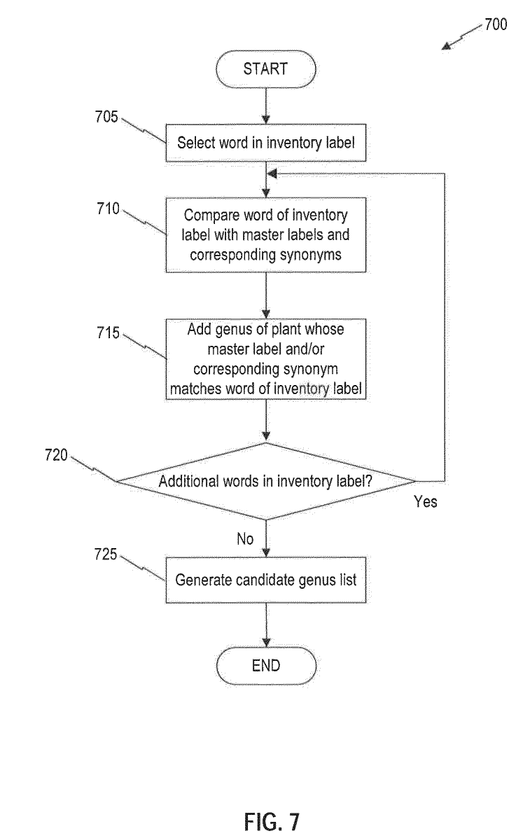

At step 320, inventory processor 220 may identify one or more candidate parent classes based on the identified inventory label. A candidate parent class may be a class of products that the inventory product may possibly be a member of. For purposes of this disclosure, the parent class may include all inherited parent classes. That is, the parent class may include the immediate parent class, and the parent class of the immediate parent class, etc. In the case of plant products, a candidate parent class may be a candidate genus, species, variety, and/or eultivar that the inventory plant belongs to. Details of step 320 will be described in more detail with respect to FIG. 7 based on a plant inventory example.

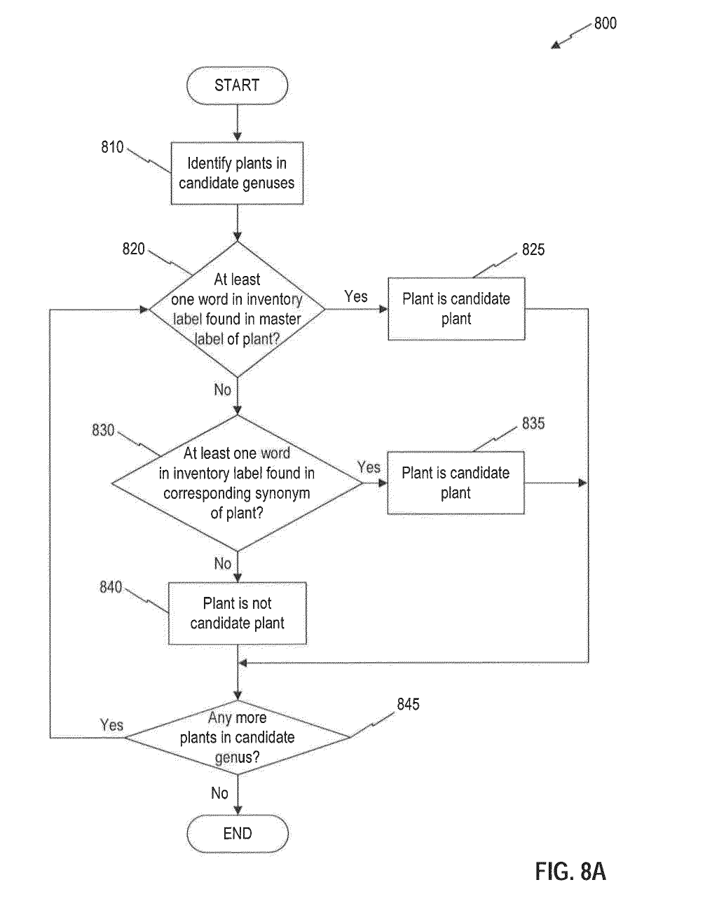

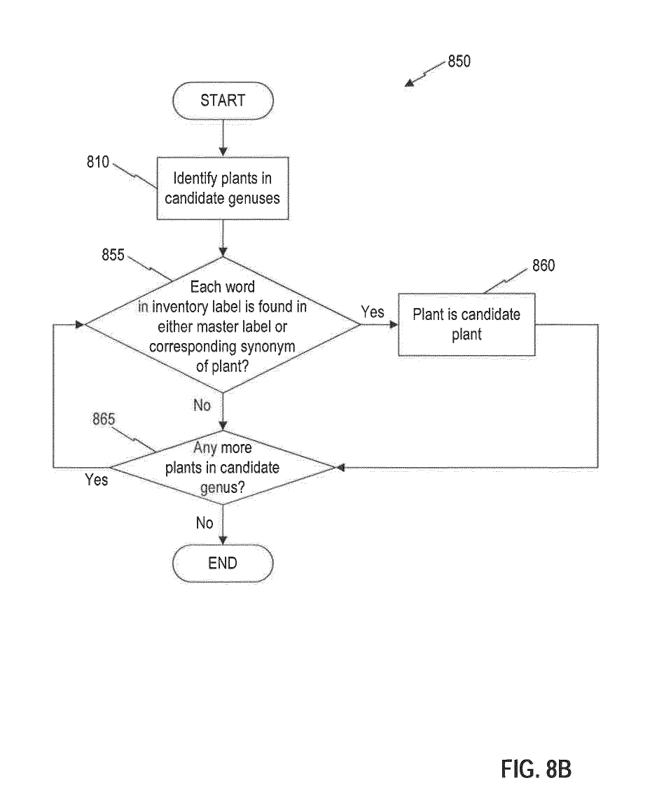

At step 330, inventory processor 220 may determine candidate products that potentially match the inventory product, based on the inventory label. Determining candidate products may include identifying products from the master list that are in the candidate parent classes, and performing a filtering process on these products for the products that match the inventory label. In some embodiments, the matching is not limited to a strict matching, but rather includes a broad matching, as will be discussed in more detail below with respect to FIG. 8 based on a plant inventory example.

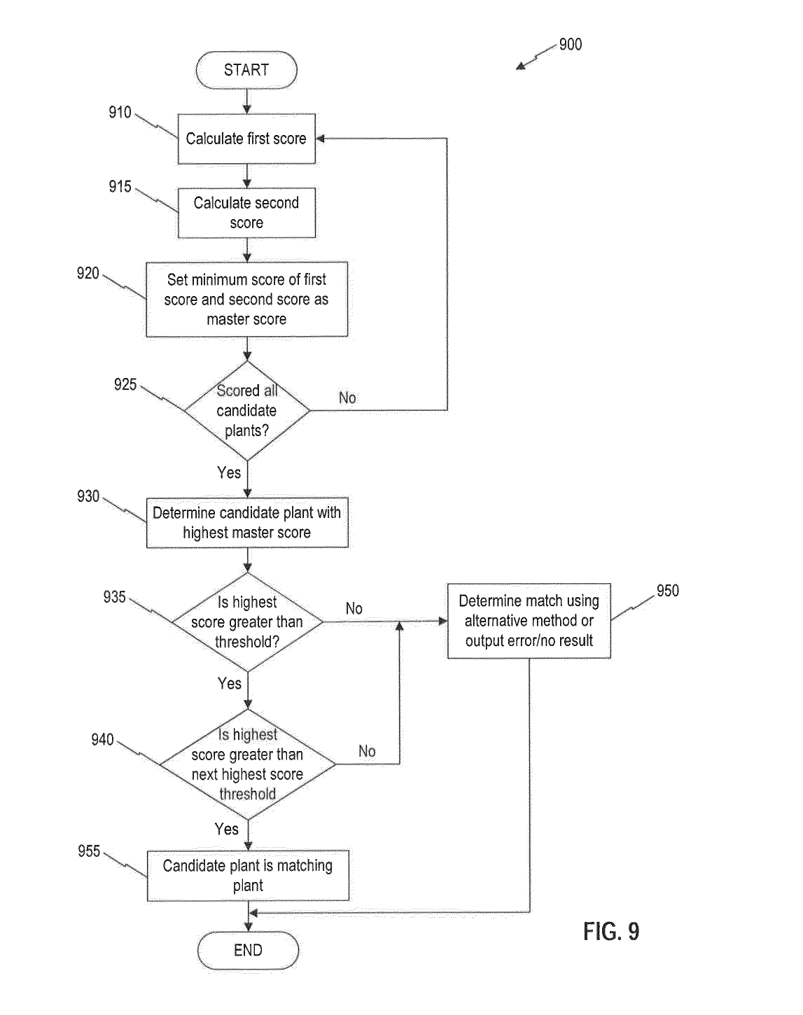

At step 340, inventory processor 220 may score the master labels of the candidate products. Scoring a master label may be based on the master label and the corresponding synonyms of the master label. At step 350, inventory processor 220 may select a product from the candidate products as being the match to the inventory product identified by the inventory label, based on the relative scores of the candidate products. A method of scoring and the selection of a matching product will be described in more detail below with respect to FIGS. 9, 10, and 11, based on a plant inventory example.

At step 360, inventory processor 220 may create a record in provider database 130 associating the matched product with the provider. In this manner, providers having the same product may be associated with a common master label for identifying the product.

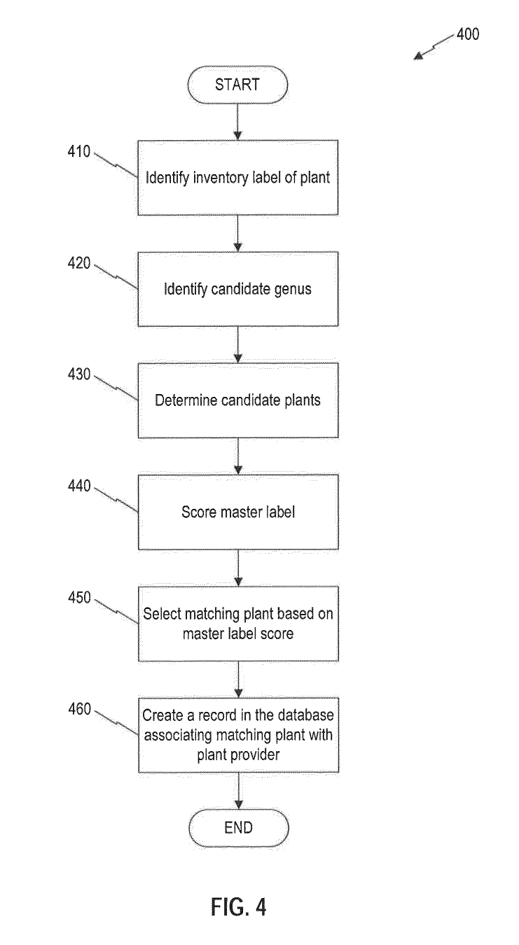

FIG. 4 depicts a method 400 of inventory processor 220 processing an inventory according to an exemplary embodiment, in which the products are specifically plants and the providers are plant providers. While the methods and systems disclosed herein refer to plants and plant providers, one of ordinary skill in the art will appreciate their utility for other products and providers.

Steps of method 400 will be described in further detail with reference to an exemplary plant inventory 530 depicted in FIG. 5A. Inventory 530 may include information that is not directly related to plant products such as, for example, the name of the provider 531, contact information 532 for the provider, the date 533 that the inventory was generated on, or a comment 534. Inventory 530 may also include a list of plant products 540. In the example of FIG. 5, each plant product 540 is listed on a separate line, and each line includes information pertaining to product 540. For example, a line corresponding to a plant product 540 may include a plant name or identifier (e.g., inventory labels 550, such as iceberg climbing, and/or plant patent number 551, such as Patent #12345), status information 553 (e.g., NEW!, On SALE!, Will be discontinued soon), and/or product specifications 554 (e.g., size of pot, size of plant, pricing, age of plant, amount of availability). Inventory 530 may list products 540 in categorical groups, based on a common parent class, such as genus 560. The inventory 530 shown in FIG. 5 lists three plants (identified by inventory labels 550 of iceberg climbing, drift rose redl, and knockout) under a category of the Rosa genus. The same inventory 530 also lists several plants (identified by inventory labels 550 of Japonicus, Jahuran, and Planiscapus ‘Nigrescens’) under a category of the Ophiopogon genus. Such groups may be referred to as genus blocks 561. Alternatively, inventory 530 may list products without being grouped into genuses, and instead list plants in alphabetical order or random order, for example, as shown in portion 562 of inventory 530.

An inventory label 550 may be a name used to Identify a specific plant product 540 in inventory 530. Inventory label 550 may be one word or may include several words, as shown by the exemplary inventory labels 550 of inventory 530 in FIG. 5A. For example, inventory 530 includes Iceberg Climbing, Drift rose redl, Knockout, Japonicus, Jaburan, Planiscapus ‘Nigrescens’, Rhododendron formosanum. Petite indigo, Japanese-hawthorn, and Bicolor iris as inventory labels 550. These inventory labels 550 are names that a plant provider may use in their inventory to describe certain plant products 540, even though other names might have been chosen. For example, instead of Knockout, the same plant may have been designated with an inventory label of Rosa radrazz, radrazz, chinesis knockout, red knockout, or the original knock out.

Steps of method 400 will be described In further detail also with reference to an exemplary master list 570 depicted in FIGS. 5B and 5C. Master list 570 may be stored as a table, a spreadsheet, database entries, text file, data objects, and/or in any other known format. Master list of 570 may include a list of master labels 571 (depicted as the middle column of master list 570 in FIG. 5B) and corresponding synonyms 572 of the master labels (depicted as the right column of master list 570 in FIG. 5B). Master label 571 may be an identifier of a distinct plant, e.g., a botanical name of a plant, and corresponding synonyms 572 may be other identifiers of the distinct plant, e.g., nicknames, common names, abbreviated names, alternative names, trade names, etc. As an example, Rosa ‘radrazz’, the master label 571 of a plant 573 in master list 570 in FIG. 5B, may also be identified by names including chinesis knockout, hybrid knock out, knock out, knockout red, knock out, knockout, knock out rose red, ho, rad razz tree, red hush, red knockout, the original knock out, and rasa radrazz, which are designated as corresponding synonyms 572 in master list 570. There is no strict requirement for which of the identifiers of a plant is master label 571 and which are corresponding synonyms 572. For example, a plant's master label 571 may instead be its common name (e.g., the original knock out), and one of the plant's corresponding synonyms 572 may be its botanical name (e.g., Rosa ‘radrazz’). Corresponding synonyms 572 may also include misspelled names that might occur when identifying a plant. For example, one of the corresponding synonyms 572 for Rhododendron indica ‘formosa’ may include formaosa, which may be a common misspelling of formosa. Sometimes a plant may be associated with only one identifier in master list 570, in which ease master list 570 may include a master label 571 for the plant but no corresponding synonyms 572 for the same plant. Such an example is shown in FIG. 5B with Rhododendron formosanum and Rhododendron indica ‘formosa purple’. Master list 570 may include tens, hundred, thousands, or millions of master labels associated with distinct plants and their corresponding synonyms.

In the exemplary master list 570 shown in FIG. 5B, the master labels 571 are generally the botanical name of the plant. For clarity, the master labels 571 are depicted as including the genus of the plant. For example, Ophiopogon is the genus of the plant Ophiopogon jaburan, Ophiopogon japonicus, Ophiopogon japonicus ‘nanus’, and Ophiopogon planiscapus ‘nigrescens’, which are master labels shown in master list 570. In some embodiments of the methods described below, the master label may be the most specific part of the botanical name. For example, jaburan (a species in the genus Ophiopogon) instead of Ophiopogon jaburan, japonicus (a species in the genus Ophiopogon) instead of Ophiopogon japonicus, or nanus (a cultivar in the species japonicus in the genus Ophiopogon) instead of Ophiopogon japonicus ‘nanus’. FIG. 5C depicts an exemplary master list 570 listing master labels 571 as the most specific part of the botanical name. In general, inventory system 140 may store, for each plant in master list 570, information about the genus, species, variety, and/or cultivar of the plant. The master label for each plant may be a combination of one or more of these names for different embodiments.

For simplicity, the examples described below will assume the embodiment that the master label includes just the most specific part of the botanical name, as shown in FIG. 5C. For example, when reference is made to the master label of Rhododendron indica ‘formosa purple’, it is assumed that the master label is formosa purple. The full botanical name is also shown in the master list of FIG. 5C to aid understanding of specific plant examples discussed below.

With reference to FIG. 4, at step 410, inventory processor 220 may identify an inventory label 550 corresponding to a plant product 540 in plant inventory 530. In one embodiment, inventor processor 220 may identify inventory label 550 based on a pre-known format of plant inventory 530. For example, a particular provider's plant inventory 530 may be formatted in lines of raw text, wherein a line includes a series of words associated with various product specifications and details, e.g., name, quantity, and dimensions. In such cases, inventory processor 220 may process plant inventory 530 line by line to identify inventory labels 550. In another example, the particular provider's inventory may be formatted in blocks, such as genus blocks 561. In such eases, inventory processor 220 may be configured to also process plant inventory 530 block by block to identify inventory labels 550.

In yet another example, formatting information may include where inventory processor 220 might expect certain types of information. For example, lines of inventory 530 may be formatted such that generally inventory label 550 comes at the beginning of the line, then product specifications 554 about the size of the plant, and the size of the pot, then quantity of the item's availability, and then pricing, as illustrated by listed items 3, 4, and 5 of inventory 530 in FIG. 5A. Inventory 530 may also include more than one type of line format, format exceptions, or lines that include or exclude some product specifications compared to other lines. For example, listed Items 1 and 2 of inventory 530 include miscellaneous status indicators 553 (e.g., NEW!, On SALE!) before inventory labels 550 (e.g., Iceberg Climbing, Drift rose redl), and listed item 1 includes a plant patent number 551 (e.g., Patent #12345) before pricing information. As another example, listed items 9 and 10 include the age of the plant product. Inventory processor 220 may be configured to recognize and handle these variations accordingly. Information about the format configuration may be input into inventory system 140, by a backend support technician or by the provider themselves, for example, before or when the first inventory 530 of a particular provider is processed. It may then be assumed that subsequent inventories received from the particular provider follow the same format configuration. In another embodiment, inventory processor 220 may be able to automatically determine the format of inventory 530, based on comparisons to known format configurations or using pattern recognition algorithms, for example.

An exemplary method 600, by which inventory processor 220 may perform step 410 and identify inventory label 550, is now described with respect to FIG. 6. In an exemplary embodiment, method 600 may be performed specifically by parser 222 of inventory processor 220. At Step 610, inventory processor 220 may identify lines and/or words in inventory 530 that should be skipped. Inventory processor 220 may skip lines of inventory 530 that are not directly related to a plant product 540. For example, inventory processor 220 may skip lines that include the name 531 and contact information 532 of the provider, date 533 that the inventory was generated on, or comments 534, as shown in Fig, 5A. Inventory processor 220 may identify words of inventory 530 that should be skipped, at least in the processing of inventory 530. For example, inventory processor 220 may identify various words such as “NEW!”, “On Sale!”, “POPULAR!”, “RARE!”, “(Bulk pricing available),” and/or “Will be discontinued soon” in inventory 530 as unneeded words. In one embodiment, inventory processor 220 may strip inventory 530 of such extraneous words. In another embodiment, inventory processor 220 may identify words that are significant information related to plant product 540 that is utilized by provider recommendation system 100. Such text may indicate that the plant product 540 is trellised, espaliered, etc. Inventory processor 220 may extract these words, e.g., “trellised” in listed item 2 of inventory 530, and save them for reassociation with plant product 540 at any time, for example, when displaying an inventory in response to a consumer search, or in the creation or update of the database record saved in provider database 130.

At Step 610, inventory processor 220 may also identify words that should be convened and converts these words accordingly. In one embodiment, inventory processor 220 may determine that a word should be converted if the word is found in a conversion list saved in storage device 225. In one example, the conversion list may comprise words that can indicate more than one variety of plant but that are usually used to indicate a specific plant. An example is the word agapanthus. Agapanthus is technically a genus that includes many varieties of plants, e.g., Agapanthus africanus, Agapanthus campamdatus, Agapanthus caulescens, Agapanthus coddii, etc. However, it may be that in almost all cases, when a nursery or plant seller uses the word agapanthus, the word is being used to refer specifically to the plant Agapanthus africanus. Therefore, the conversion list may include the word agapanthus, so that when inventory processor 220 encounters the word agapanthus by itself for a plant product 540 in inventory 530, inventory processor 220 would substitute agapanthus With Agapanthus africanus when processing the inventory.

At step 620, inventory processor 220 may identify a genus block 561 of line entries in inventory 530. A genus block, such as genus block 561, may be a group of entries that are indicated as being associated with the same genus, for example with genus block identifier 560. The genus block identifier 560 may then be utilized, for example, by including it as one of the candidate genuses when identifying candidate genuses at step 420 of FIG. 4. In an alternate embodiment, step 420 may be skipped, as it may be advantageous to assume that genus block identifier 560 is correct and identifies the best candidate genus.

At step 630, inventory processor 220 may identify and convert text lines into one or more fields. Inventory processor 220 may determine portions of the raw text that correspond to a name, quantity, size, comment, price, and/or other fields. For example, inventory processor 220 may convert the line corresponding to the listed item 1 in inventory 530 (“Iceberg Climbing Patent #12345 3′ bush 2′ pot 57 $23.14/bush”) into a name field (which may include “Iceberg Climbing” and “Patent #12345”), a size field (“3′ bush” and “2′ pot”), a quantity field (“57”), and a price field (“$23.14/bush”).

At step 640, inventory processor may extract inventory label 550 (e.g., “Iceberg Climbing” of listed item 1 in inventory 530) based on the content of the name field (whose content may include “Iceberg Climbing” and “Patent #12345”). In one embodiment, inventory processor 220 may save the other fields to later be reassociated with the inventory plant in the database record stored in provider database 130. For example, after inventory processor 220 has determined a matching master label that corresponds to plant product 540 indicated as “Iceberg climbing” in listed item 1, and inventory processor 220 creates or updates a record in provider database 130 associating the provider 531 with the matching master label, inventory processor 220 may also include information found in, for example, the size, quantity, and price fields (3′ bush, 2′ pot, 57, $23.14/bush) in that same record, inventory processor 220 may also include the original inventory label.

At step 650, inventory processor 220 may remove non-alphanumeric text from inventory label 550, such as hyphens and apostrophes. For example, inventory processor 220 may convert “Japanese-hawthorn,” of listed Items 9 and 10 of inventory 530, as “Japanese hawthorn.” In other embodiments, inventory processor 220 may concatenate words in the inventory label, e.g., “Japanese-hawthorn.” As another example, inventory processor 220 may convert “Planiscapus ‘Nigrescens,’” of listed item 6 of inventory 530, as “Planiscapus Nigrescens. ” As a result of method 600, inventory processor 220 may generate a sanitized inventory label that is then ready for inventory processor 220 to utilize in finding a matching plant in master list 570.

With, continued reference to FIG. 4, at step 420, inventory processor 220 may identify candidate genuses based on the inventory label 550 identified at step 410. A candidate genus may be any genus that inventory processor 220 determines is possibly the genus of the inventory plant associated with inventory label 550.

An exemplary method 700 by which inventory processor 220 may perform step 420 and identify candidate genuses is now described with respect to FIG. 7. At 705, inventory processor 220 may select a word in the inventory label identified at step 420. At step 710, inventory processor 220 may compare the inventory label word with master labels 571 and corresponding synonyms 572 of master list 570, and determine if any words of master labels 571 and corresponding synonyms 572 match the inventory label word.

As an example, “bicolor iris” may be the identified inventory label 550 (in listed item 11 of inventory 530). At step 710, inventory processor 220 may compare the word “bicolor” of “bicolor iris” to master labels 571 and corresponding synonyms 572 that are in master list 570. It should be noted that master list 570 depicted in FIG. 5B (or FIG. 5C) depicts only a portion of an exemplary master list, and inventory processor 220 may compare “bicolor” to many more words than just those shown in FIG. 5B (or FIG. 5C). Inventory processor 220 may identify corresponding synonym 574, cyrtospadix bicolor, as matching inventory word “bicolor,” because cyrtospadix bicolor includes the word “bicolor.” As illustrated by this example, the term “matching” may include a looser type of matching in which the matching word (e.g. cyrtospadix bicolor) does not need to strictly match the inventory label word (“bicolor”) letter for letter, but can match by at least containing the inventory label word. In another embodiment, “matching” may also include where the matching word contains the inventory label word but with one or two letters difference (i.e., letters added, missing, and/or changed). In general, for purposes of this disclosure, the term “matching” may include looser types of matching. If a stricter matching is being referred to, e.g., exact matching of letter by letter, such matching is referred to as “exact matching.”

In one embodiment, to determine if the inventory word matches any of master labels 571 and corresponding synonyms 572, inventory processor 220 may compare the inventory label word to a concatenated format of master labels 571 and corresponding synonyms 572. As an example, if the identified inventory label word is “knockout,” as may be the case when inventory processor 220 processes listed item 3 of inventory 530 in FIG. 5A, inventory processor 220 may determine whether “knockout” matches any master labels 571 and corresponding synonyms 572 of master list 570. Inventory processor 220 may determine that “knockout” matches corresponding synonym 575, knock out francis meilland. This matching may be due to inventory processor 220 concatenating “knock out francis meilland” to “knockoutfrancismeiiland,” before comparing it to the inventory label word “knockout.” Based on the concatenation, or equivalently by ignoring the blank letter spaces, inventory processor 220 may determine that “knockout” matches knock out francis meilland, since the word “knockout” is found in “knockoutfrancismeiiland.”

It should be noted that some embodiments that include looser matching, as discussed above, facilitate some flexibility in being able to match words despite misspellings that may be present in either inventory 530 or master list 570, e.g., if matching includes the possibility of one or two letters not matching. Alternatively, in one embodiment, the issue of misspellings may be addressed by the explicit inclusion of misspelled versions of names in the list of corresponding synonyms 572, as discussed above In the general description of corresponding synonyms.

At step 715, inventory processor 220 may add the genuses of the plants, whose master label and/or corresponding synonym matches the inventory word, to a list of candidate genuses. As there may be more than one master label or corresponding synonym in the master list that matches an inventory word, and the more than one master labels or corresponding synonyms may be of different genuses, inventory processor 220 may add one or more genuses to the list of candidate genuses at step 715. For example, inventory processor 220 may determine that corresponding synonym 574 cyrtospadix bicolor matches the inventory word “bicolor,” as discussed above. As a result, inventory processor 220 may add the genus that cyrtospadix bicolor is a member of, i.e., caladium to the list of candidate genuses. Inventory processor 220 may also determine that master label 576 “Dietes bicolor,” as well as any of its corresponding synonyms 577 bicolor, bi colored, bicolor morea, dietes vegeta bicolor, iris african bi color white, iris bicolor, iris lily bicolor, or “moraea bicolor” (all of which are possible names for the plant Dietes bicolor) match the inventory word “bicolor.” Inventory processor 220 may therefore add the genus of the plant Dietes bicolor, i.e., dietes, to the candidate genus list. The candidate genus list may include other genuses as result of inventory processor 220 finding a match between the inventory word “bicolor” and other master labels 571 and corresponding synonyms 572.

At step 720, inventory processor 220 may determine whether there are additional words in the identified inventory label 550. If there are more words (step 720: YES), inventory processor 220 may repeat steps 710 and 715 for the others words in inventory label 550 (e.g. “iris” in the inventory label “bicolor iris”), adding any additional genus of matching master labels 571 and corresponding synonyms 572 to the candidate genus list. In the example of “bicolor iris,” inventory processor may repeat steps 710 and 715 for the inventory word “iris.” As with other steps of the disclosed methods, steps 710 and 715 may be performed for multiple words in parallel, or serially. That is, method 700 is not limited to a serial, recursive loop as exemplarily depicted in FIG. 7.

If there are no more additional words (step 720: NO), inventory processor 220 may generate the list of candidate genuses at step 725. In one embodiment, inventory processor 220 may also identify candidate genuses by performing steps 710 and 716, but may compare two words at a time (instead of one) of the inventory label to master labels 571 and corresponding synonyms 572. For example, in the case of “knock out rose,” inventory processor 220 may determine whether “knock out” and “out rose” match any master labels 571 or corresponding synonyms 572. In one embodiment, inventory processor 220 may also concatenate the two words, e.g. “knockout” and “outrose,” when looking for matches in master labels 571 and corresponding synonyms 572. In the example of “knockout” and “outrose,” the words are adjacent in inventory label 550. In another embodiment, inventory processor 220 may also concatenate two non-adjacent words, e.g., “knockrose.”

In an alternative embodiment, inventory processor 220 may determine a genus is a candidate genus if a predetermined minimum number of words in inventory label 550 are found in the master label 571 or corresponding synonym 572 of a plant in the genus. For example, if inventory processor determines that all words but one (or two, three, etc.) words of inventory label 550 are found in a plant's master label and/or corresponding synonyms, inventory label may determine that the genus of that plant is a candidate genus.

In the example of “bicoior iris,” inventory processor 220 may generate the following candidate list at step 725, which includes caladium and dietes, examples that are discussed in detail above;
aconitum, adenocaulon, adesmia, adromischus, agalmyia, aloe, andropogon, anigozanthos, aspalaths, avicennia, baptisia, hlechnum, bryoria, bidbophyllum, burmannia, caladium, calendula, caniua, carex, caryopteris, cattleya, cereus, chasmanthe, cheilanlhes, chirita, chrysophyllum, collinsia, correa, corynabutilon, curcuma, cyclopogon, cyrtandra. dalea, decatropis, delphinium, dendropemon, diandrolyra, dianthus, dichrocephala, didymo carpus, dietes, dioclea, dracaena, drosanthemum, echeveria, eleocharis, elizabetha, eragrostis, eriogonum, eucomis, eucrosia, euphorbia, excoecaria, fascicularia, gasteria, glossoloma, grewia, guadua, gymnocalycium, gynura, gypsophila, hamatocactus, hemigraphis, hippeastrum, hoya, impatiens, iris, krameria, lampranthus, leptosiphon, lespedeza, linanthus, lomatium, lupmus, maiva, maranta, niarianthus, masdevallia, mimulus, myxotrickum, narcissus, nautilocalyx, navarrelia, neomarica, orthotrichum, pachypodium, pappophorum, pariana, parkia. pemtemon, phacelia. phycella, picea, pipiochaetiwn, pittasporum, platanthera, pourouma, pseuderanthemum, pseudocaryopteris, quercus, rhododendron, rhytidophyllum, rasa, saiix, sarcogyne, scahiosa, scrophularia, senecio, sesbania, solatium, solidago, sorghum, spiranthes, stilpnopappus, tetrazygia, feucrium, thelocactus, tkeobroma, tigridia, tournefortia, trigonella, vanda, verbascum. viola, vitex, vitis, xylococcus, zinnia, zygogynum

With continued reference to FIG. 4, at step 430, inventory processor 220 may determine candidate plants, which may be plants identified as being possible matches for the inventory label identified at step 420. Inventory processor 220 may determine candidate plants by identifying plants in master list 570 that are in one of the candidate genuses identified at step 420. Inventory processor 220 may also determine candidate plants by further performing a filtering process on the plants identified as being in one of the candidate genuses, based on a matching with the inventory label.

An exemplary method 800 by which inventory processor 220 may perform step 430 and determine candidate plants is now described with respect to FIG. 8A. At step 810, inventory processor 220 may identify plants in master list 570 that are in the candidate genuses identified at step 420. Of the plants that inventory processor 220 identifies at step 810, inventory processor 220 may further filter these plants to identify candidate plants. For example, for a given plant identified at step 810, inventory processor 220 may determine, e.g., by performing steps 820 to 840, whether the plant is a candidate plant, as described below.

As an example of step 810, when inventory label 550 is “bicolor iris,” inventory processor 220 may identify plants in master list 570 that are in the candidate genuses exemplarily generated for “bicolor iris” at step 725, which are listed above. Plants identified at step 810 as being in the candidate genuses may include caladium ‘florida irish lace’ (a plant in the identified candidate genus caladium), dietes bicolor (a plant in the identified candidate genus dietes), rhododendron indica ‘formosapurple’ (a plant in the identified candidate genus rhododendron), and quercus geminate (a plant in the identified candidate genus quercus), as well as other plants in the genuses caladium, dietes, rhododendron, quercus, and the other candidate genuses generated at step 725.

At step 820, inventory processor 220 may determine whether at least one word in inventory label 550 is found in die master label 571 of the plant. As discussed above with respect to FIG. 7, the words of the master label 571 may be concatenated before determining whether the inventory label word is found in the master label 571. If the word is found in master label 571 (step 820: YES), inventory processor 220 may determine that the plant is a candidate plant (step 825). If at least one word is not found in master label 571 (step 820: NO), inventory processor 220 may proceed to step 830.

As an example of step 820, inventory processor 220 may determine that the inventory label “bicolor iris” has at least one word (i.e., “bicolor”) that is found in master label of dietes bicolor (e.g., master label bicolor). Because an inventory word Is found In the master label of dietes bicolor (step 820: YES), inventory processor 220 may determine that dietes bicolor is a candidate plant (step 825).

In another example, inventory processor 220 may determine that the inventory label “bicolor iris” has at least one word (i.e., “iris”) that is found in the master label of caladium ‘fiorida irish lace’ (e.g., master label florida irish lace) (step 820: YES), because “iris” is found in the word irish. Therefore, inventory processor 220 may determine that caladium ‘florida irish lace’ is a candidate plant (step 825).

If the master label at step 820 is instead of rhododendron indica ‘formosa purple’ (e.g., master label jormosa purple) or quercus geminate (e.g., master label geminate), inventory processor 220 may determine that at least one word of “bicolor iris” is not found in the master label (step 820: NO).

At step 830, inventory processor 220 may determine whether at least one word in the inventory label is found in one of the corresponding synonyms 572 of the candidate genus plant (step 830). The words of corresponding synonyms 572 may also be concatenated before determining whether at least one word in inventory label 550 Is found in one of the corresponding synonyms 572. If the word is found in one of the corresponding synonyms (step 830: YES), inventory processor 220 may determine that the plant is a candidate plant (step 835). If the word is not found in one of the corresponding synonyms (step 830: NO), inventory processor 220 may determine that the plant is not a candidate plant (step 840).

As an example, if the candidate genus plant is rhododendron indica ‘formosa purple’ (which may have no corresponding synonyms) or quercus geminata (which may have a corresponding synonym of “sand live oak”), inventory processor 220 may determine that at least one word of the inventory label “bicolor iris” is not found in the corresponding synonyms. As a result (step 830: NO), inventor/processor 220 may determine that, the plant rhododendron indica ‘formosa purple’ or the plant quercus geminate is not a candidate plant (step 840).

At step 845, inventory processor may determine whether there are any more plants that are in one of the candidate genuses as identified at step 810. If there are more plants (step 845: YES), inventory processor 220 may repeat steps 820 to 840 for the remaining plants that are in the candidate genuses.

FIG. 8B depicts an exemplary method 850 by which inventory processor 220 may-perform step 430 and determine candidate plants according to another embodiment. At step 810, inventory processor 220 may identify plants in master list 570 that are in the candidate genuses identified at step 420, as described above with respect to FIG. 8A. Of the plants that, inventory processor 220 identifies at step 810, inventory processor 220 may further filter these plants to identify candidate plants by, as an example, performing steps 855 to 865 described below.

At step 855, inventory processor 220 may determine whether each word in inventory label 550 is found in either master label 571 or corresponding synonym 572 of the plant. If each word in inventory label 550 is found in either master label 571 or corresponding synonym 572 of the plant (step 855: YES), inventory processor 220 may determine that the plant is a candidate plant (step 860). If each word in inventory label 550 is not found in either master label 571 or corresponding synonym 572 of the plant (step 855: NO), inventory processor 220 may determine that the plant is not a candidate plant (step 865). In another embodiment, at step 855, inventory processor 220 may determine whether at least a minimum number of words of inventory label 550 are found in either master label 571 or corresponding synonym 572. For example, if all but one (or two, three, etc.) word of the inventory label 550 are found In either master label 571 or corresponding synonym 572, inventory processor 220 may determine that the plant is a candidate plant (step 860). Otherwise, if more than one (or two, three, etc.) words of the inventory label 550 are not found in either master label 571 or corresponding synonym 572, inventory processor may determine that the plant is not a candidate plant (step 865).

An example of method 850 is now described using the same exemplary inventory label of “bicoior iris.” At step 855, for the plant caladium ‘florida irish lace’, the word “bicolor” is found in the corresponding synonym caladium bicolor, and alternatively in cyrtospadix bicolor. The word “iris” is found in the master label of caladium ‘florida irish lace’ (i.e., in the word “irish” in florida irish lace). Because all of the words of the inventory label “bicoior iris” are found in the master label or corresponding synonym of the plant caladium ‘florida irish lace’ (step 855: YES), inventory processor 220 may determine that caladium ‘florida irish lace’ is a candidate plant (step 860). Similarly, because both “bicoior” and “iris” are found in either the master label or corresponding synonyms of the plant dietes bicoior (i.e., “bicolor” is found in the master label dietes bicolor, and “iris” is found in the corresponding synonym dietes vegeta bicoior yellow african iris, and alternatively in corresponding synonyms iris african bi color white, iris bicoior, iris lily bicoior, and yellow african iris) (step 855: YES), inventory processor may determine that dietes bicoior is also a candidate plant (step 860).

In contrast, at step 855, if only “bicolor” is found in the master label or corresponding synonym of a plant, but not “iris” (step 855: NO), inventory processor may determine that such plant is not a candidate plant (step 865).

As a result of method 850 (i.e., step 430 of FIG. 4), inventory processor 220 may determine that the list of candidate plants for the inventory label “bicolor iris” are caladium ‘florida irish lace’ and dietes bicolor.

Exemplary results of the methods of FIG. 6, 7, and 8B (i.e., steps 410, 420, and 430 of FIG. 4) for “bicolor iris,” as discussed in detail above, are summarized in Example 1 below.

### EXAMPLE 1

Inventory Label:
bicolor iris

Candidate Genus:
aconitum, adenocaulon, adesmia, adromischus, agalmyla, aloe, andropogon, ardgozanthos. aspalaths, avicennia, baptisia, blechnum, bryoria, bulbophyllum, burmannia, caladium, calendula, cantua, carex, caryopteris, cattleya, cereus, chasmanihe, cheilanthes, chirita, chrysophyUum, collinsia, correa, corynabutilort, curcuma, cyclopogon, cyrtandra, dalea, decatropis, delphinium., dendropemon, dkmdrolyra, dianthus, dichrocephala, didymocarpus, dietes, dioclea, dracaena, drosanthemum, echeveria, eleocharis, elizabetha, eragrostis, eriogonum, eucomis, eucrosia, euphorbia, excoecaria. fascicularia, gasteria, glossoloma, grewia, guadua, gymnocalycium, gynura, gypsophila, hamaiocactns, hemigraphis, hippeastrxmi, hoya, impaiiens, iris, krameria, lampranthus, leptosiphon, lespedeza, linanthus, lornatium, lupinus, malva, marania, marianthus, masdevallia, mimulus, myxotrichimi, narcissus, nauiilocalyx, navarretia, neomarica, orthotrichum, pachypodium, pappophorwn, pariana, parkia, penstemon, phacelia, phycella, picea, piptochaetium, pittosporum, platanthera, pourowna, pseuderanthemum, pseudocaryopteris, quercus, rhododendron, rhytidophyllum, rosa, salix, sarcogyne, scahiosa, scropkularia, senecio, sesbania, solarium, solidago, sorghum, spiranthes, stilpnopappus, tetrazygia, leucrium, thelocactus, theobroma, tigridia, tournejortia, trigonella, vanda, verbascum, viola, vitex, vitis, xylococcus, zinnia, zygogynum

Candidate Plants:
(Plant/Master Label/Corresponding Synonyms)
Caladium ‘florida irish lace’/florida irish lace/caladium, bicolor, caladium hortulanum, cyrtospadix bicolor
Dietes bicolor/bicolor/bicolor, bi colored bicolor morea, dietes vegeta bicolor yellow African iris, fortnight, iris african bi color white, iris bicolor, iris lily bicolor, moraea bicolor, yellow african iris, yellow

Other examples of the results of the methods of FIGS. 6, 7, and 8B (i.e., steps 410, 420, and 430) are given below, with respect to exemplary inventory labels “knock out rose,” “mondo grass,” and “formosa azalea.” These results may be generated in a manner similar to that as detailed above for the example of “bicolor iris.”

### EXAMPLE 2

Inventory Label:
knock out rose

Candidate Genus:
rosa

Candidate Plants:
(Plant/Master Label/Corresponding Synonyms)
Rosa ‘iceberg’/iceberg/iceberg climbing, knockout iceberg, white iceberg
Rosa ‘livin’ easy’/livin easy/harwelcome, knockout livin’ easy, livin’ easy, living easy
Rosa ‘meigalpio’/meigalpio/drift red knockout, drift rose redl, drift rose red, red drift, red drift rose
Rosa ‘meijocos’/meifocos/drift pink knockout, drift rose pinkl, drift rose pink, pink drift, pink drift rose
Rosa ‘meitroni’/meitroni/francis meilland, knock out francis meilland
Rosa ‘outta the blue’/outta the blue/knockout outta the blue
Rosa ‘radcarn’/radcarn/knockout peppermint, peppermint pop
Rosa ‘radcon’/radcon/chinensis pink knock out, pink, knockout, the pink knock out, rosa radcon
Rosa ‘radcor’/radcor/rainbow knockout
Rosa ‘radrazz’/radrazz/chinesis knockout, hybrid knock out, knck out, knockout red, knock out, knockout, knock out rose red, ko, rad razz tree, red bush, red knockout, the original knock out, rosa radrazz
Rosa ‘radsunny’/radsunny/ko sunny, sunny knockout, sunny, sunny tree, sunny yellow, the sunny knock out rosa radsunny, yellow knock out, yellow knockout
Rosa ‘radtko’/radtko/chinensis double red knock o, double knock out, double knockout, double knockout tree red, double ko, double red, knockout double red, knockout double, knock out rose double red, rose double knock out, the double knock out, rosa radtko
Rosa ‘radtkopink’/radtkopink/chinensis double pink knock outdouble, double knockout tree pink, double pink, knock out rose double pink, pink: double knockout, the double pink knock out, rosa radtkopink
Rosa ‘radwhite’/radwhite/knock out white, outtm radwhiie, rosa knock out white out, rosa whiteoui, white out, white out tree
Rosa ‘radyod’/radyod/blushing knockout, blushing pink, blushing, knockout blushing pink patented, knock out blushing pink, knock out blush
Rosa ‘sprothrive’/sprothrive/thrive, tm knockout descendant

### EXAMPLE 3

Inventory Label:
mondo grass

Candidate Genus:
acorus, andropogon, calamagrostis, carex, chasmanthium, cortaderia, deschampsia, eragrosiis, euonymus, festuca, juncus, leymus, liriope, melinis, miscanthus, muhlenbergia, nassella, ophiopogon, panicum. pennisetum, perovskia, phalaris, schizachyrium, sorghastrum. spartina, sporobolus

Candidate Plants:
(Plant/Master Label/Corresponding Synonyms)
Ophiopogon jaburan/jaburan/curly mondo grass, lillyturf, alateria jaburan, white lilyturf
Ophiopogon japonicus/japonicus/convallaria japonica, green, mondo grass, mondo-grass, mondo, monkey grass, ophiopogon mondo, ophiopogon chekiangensis, reg. mondo, regular, snake's-beard

Ophiopogon japonicus ‘nanus’/nanus/dwarf mondo, dwarf, japonicas nana, mini, mondo grass dwarf, nana dwarf, nana, nanusrnondo
Ophiopogon pianiscapus ‘nigrescens’/nigrescens/black mondo, black monkey grass, jap black mondo

### EXAMPLE 4

Inventory Label:
formosa azalea

Candidate Genus:
achillea, acourtia, agalmyla, aliciella, aquilegia, armeria, astilbe, banksia, besleria, boechera, brachyscome, camellia, carex, char a, columnea, crataegus, dalea, dicentra, dryandra, dudleya, echeandia, echinopsis, erica, fouquieria, gilia, grevillea, halymenia, hedyotis, hyparrhenia, impatiens, kadua, lambertia, lechenaultia, lespedeza, leyeesteria, liberiia, mammillaria, malucana, mnesithea, neciouxia, parodia, petrocosmea, pieris, randia, rhododendron, ruellia, sabatia, sarracenia, sesbania, sophora, swainsona. townsendia, vavilovia, veronica, vriesea, wisteria, zapoieca

Candidate Plants:
(Plant/Master Label/Corresponding Synonyms)
Rhododendron formosanum/formosanum/
Rhododendron indica ‘formosa’/formosa/formaosa, ‘formosa pink’, formosa pink, large pink
Rhododendron indica ‘formosa lavender’/formosa lavender/large purple, lavender, lavenderformosa, lav. formosa
Rhododendron indica ‘formosa purple’/formosa purple i
Rhododendron indica ‘formosa red’/formosa red /formosa red, large red, red purple
Rhododendron indica ‘judge solomon’/judge solomon/formosa judge solomon pink, formosa judge solomon, judge soloman
   The above examples will be referred to in discussing further methods of processing the inventory, discussed below.

With continued reference to FIG. 4, at step 440, inventory processor 220 may score the master labels of the candidate plants determined at step 430. At step 450, inventory processor 220 may select one of the candidate plants as being the match to the inventory label, based on. the score,

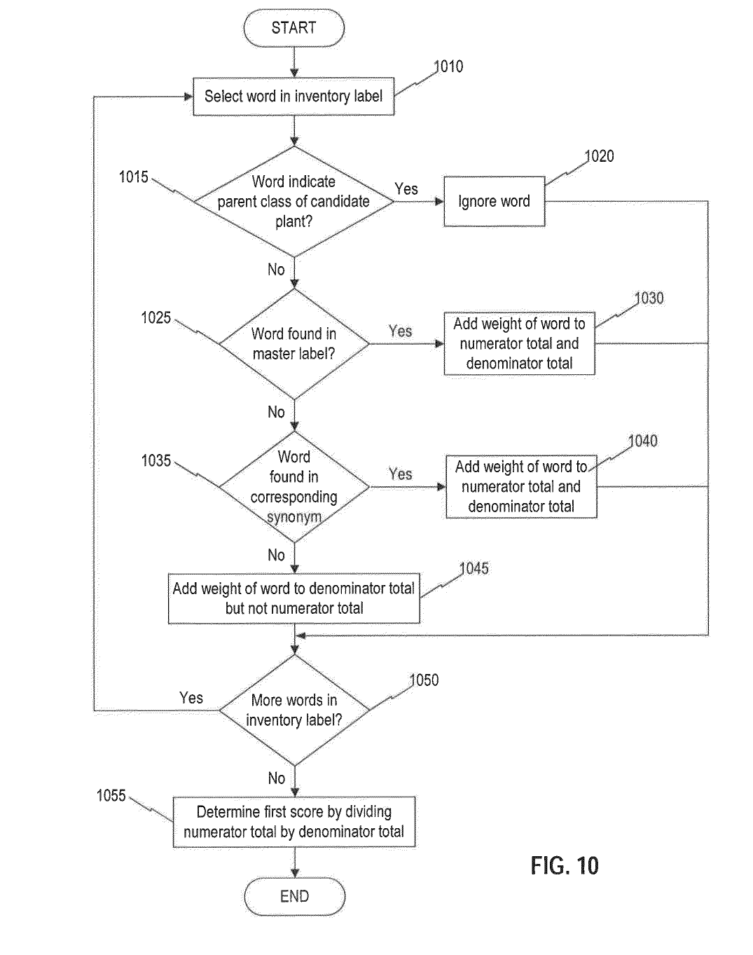

FIG. 9 depicts an exemplary method 900 by which inventory processor 220 may perform step 440 of scoring each master label of the candidate plants, and step 450 of selecting a plant as the matched plant based on. the master label scores. At step 910, inventory processor 220 may calculate a first score of the master label 571 of a particular candidate plant. In one embodiment, the first score may be calculated according to an exemplary method 1000 depicted In FIG. 10,

Exemplary method 1000 for calculating a first score is described in more detail now. At step 1010 of FIG. 10, inventory processor 220 may select a word in the inventory label. At step 1015, inventory processor 220 may determine whether the inventory label word indicates a parent class of the master label that is being scored. In the example of plant products, the parent class may be the genus, species, variety, and/or cultivar, in which the candidate plant belongs. If the inventory label word does indicate a parent class of the master label (step 1015: YES), then inventory processor 220 may ignore the inventory label word in the scoring process (step 1020), If the inventory label word does not indicate a parent class of the master label (step 1015: NO), then inventory processor 220 may proceed to step 1025.

An example of steps 1010 and 1015 will be described using the inventory label “knock out rose.” Example 2 above shows the results of inventory processor 220 determining the candidate plants for the inventory label “knock out rose.” To score one of these candidate plants, e.g., Rosa ‘iceberg’, inventory processor 220 may select a word in the inventory label (e.g., either “knock,” “out,” or “rose”), and determine whether the inventory label word indicates a parent class of the candidate plant, in this example, Rosa ‘iceberg.’ For the words “knock” or “out,” inventory processor 220 may determine that these words do not indicate a parent class of Rosa ‘iceberg’ (step 1015: NO), and as a result, may proceed to step 1025. However, for the word “rose,” inventory processor 220 may determine that “rose” indicates a parent class (in this case, the genus) of Rosa ‘iceberg’ (step 1015: YES), and as a result, inventory processor 220 may ignore “rose” in the scoring process (step 1020). Note that in the example of “rose” as the inventory label word and Rosa ‘iceberg’ as the master label, that “rose” is ignored even if it is not exactly Rosa, the name of the genus of Rosa ‘iceberg’. In this example, “rose” is a synonym of Rosa, and inventory processor 220 may be configured to recognize synonyms of genus names.

At step 1025, inventory processor 220 may determine whether the inventory label word is found in master label 571 of the candidate plant (step 1025). If the inventory label word is found in the master label (step 1025: YES), then inventory processor 220 may add a weight of the (inventory label) word to a numerator total N₁ and to a denominator total D₁ (step 1030). If the inventory label word is not found in the master label (step 1025: NO), then inventory processor 220 may proceed to step 1035. inventory processor 220 may concatenate the words in the master label 571 before performing step 1025 to determine whether the inventory word is found in master label 571.

Continuing the example of “knock out rose” as inventory label 550 and Rosa ‘iceberg’ as one of the candidate plants, inventory processor 220 may determine whether an inventory label word, e.g. “knock” or “out.” (but not “rose,” since “rose” is ignored at step 1020), is found in the master label of Rosa ‘iceberg’ (e.g. master label iceberg). In this example, inventory processor 220 may determine that the inventory word, “knock” or “out”, is not found in the master label of Rosa ‘iceberg’ (step 1025: NO), and may then proceed to step 1035.

Another example for step 1025 is described using a different inventory label example, for illustrative purposes. In Example 4 above, the inventory label is “formosa azalea,” and at step 1025, inventory processor 220 may compare inventory label word “formosa” with one of the candidate plants, e.g., Rhododendron formosanum. Inventory processor 220 may determine that the inventory label word “formosa” is found in the master label of Rhododendron formosanum (e.g., master label formosanum) (step 1025: YES). Inventory processor 220 may then add a weight of the word “formosa” to a numerator total N₁ and to a denominator total D₁.

In one embodiment, the weight of the inventory label word that is added to the numerator total N; and/or the denominator total D₁ may be the count of letters in the inventory label word. For example, the weight of the word “formosa” may be 7. In another embodiment, the weight of the inventory label word may be the count of letters in the inventory label word, up to a maximum. For example, the maximum may be set at 6. In which case, the weight of the word “formosa” is 6 (instead of 7). In yet another embodiment, the weight of the inventory label word may be pre-assigned based on statistical analysis of the significance that the particular word has in indicating a unique plant. Other schemes of weighting words may be used, according to the particularities of the system and situation.

If the inventory label word is not found in the master label 571 (step 1025: NO), then at step 1035, inventory processor 220 determine whether the inventory label word is found in at least one of the corresponding synonyms 572 of the candidate plant. If the inventory label word is found in a corresponding synonym 572 (step 1035: YES), then inventory processor 220 may add a weight of the inventory label word to the numerator total Nj and to the denominator total D₁ (step 1040).

For example, for the inventory label “knock out rose” and the candidate plant Rosa ‘iceberg’, inventory processor 220 may determine that the word “knock” is found in a corresponding synonym 572 of Rosa ‘iceberg’, e.g., knockout iceberg (step 1035: YES). Inventory processor 220 may then add a weight, of the word “knock” to the numerator total N₁ and to the denominator total D₁ (step 1040).

If the inventory label word is not found In a corresponding synonym 572, in addition to not being found in the master label 571 (step 1035: NO), then inventory processor 220 may add a weight of the inventory label word to the denominator total Di but not the numerator total N₁ (step 1045). For step 1035, inventory processor 220 may concatenate the corresponding synonym before determining whether the inventory label word is found in the corresponding synonym.

At step 1050, inventory processor 220 may check if there are more words in the inventory label. If there are more words in the inventory label (step 1050: YES), inventory processor may repeat steps 1010 to 1045 for the remaining inventory label words. If there are no more words in the inventory label (step 1050: NO), inventory processor may determine the first score for the master label by dividing the numerator total N₁ by the denominator total D₁ (i.e., N₁/D₁) (step 1055).

An example of a first scoring according to the full exemplary method 1000 is now described, for clarity and illustrative purposes, using the example of inventory label “knock out rose” and candidate plant Rosa ‘iceberg’, with master label iceberg and corresponding synonyms iceberg climbing, knockout iceberg, and white iceberg.

At step 1010, inventory processor 220 may select the word “knock” from the inventory label “knock out rose.” At step 1015, inventory processor 220 may determine whether “knock” indicates a parent, class of the candidate plant, i.e., Rosa ‘iceberg’. Inventory processor 220 may determine that “knock” does not indicate a parent class (step 1015: NO). Inventory processor 220 may proceed to determine whether “knock” is found In the master label iceberg, at step 1025. Inventory processor 220 may determine that “knock” is not found In iceberg, and proceed to determine whether “knock” is found in any corresponding synonyms of iceberg, at step 1035. Inventory processor 220 may determine that “knock” is found in the corresponding synonym knockout iceberg (step 1035: YES), and add a weight of the word “knock” to a numerator total N₁ and a denominator total D₁ (step 1040). In the example in which the weight is the count of letters up to a maximum of 6, the weight of “knock” is 5. Therefore, the numerator total becomes 5 and the denominator total becomes 5.

At step 1050, inventory processor may determine whether there are more words in the inventory label “knock out rose.” After determining that there are more words (step 1050: YES), inventory processor may repeat steps 1010 to 1045 tor the next word in “knock out rose,” i.e. “out.” “Out” does not indicate a parent class (step 1015: NO), is not found in the master label iceberg (step 1025: NO), but is found in corresponding synonym knockout iceberg (step 1035: YES). Therefore, inventory processor 220 may add a weight of the word “out” to the numerator total N₁ and the denominator total D₁ (step 1040). As a result, the numerator total becomes 8 (the sum of 5, which was the previous value of N₁, and 3, the weight of “out”), and the denominator total becomes 8 (the sum of 5, which was the previous value of N₁, and 3, the weight of “out”).

At step 1050 again, inventory processor 220 may determine whether there are more words in the inventory label “knock out rose.” After determining that there are more words (step 1050: YES), inventory processor 220 may repeat steps 1010 to 1045 for the next word in “knock out rose,” i.e. “rose.” At step 1015, inventory processor 220 may determine that “rose” indicates a parent class, i.e., genus, of Rosa ‘iceberg’ (step 1015; YES), and therefore ignore the word “rose” (step 1020),

At step 1050 again, inventory processor 220 may determine that there are no more words in the inventory label “knock out rose” (step 1050: NO). At step 1055, inventory processor 220 may determine the first, score for Rosa ‘iceberg’ by dividing the numerator total N₁, by the denominator total D₁, i.e., 8, resulting in a first score of 1.0 for the master label of Rosa ‘iceberg’.

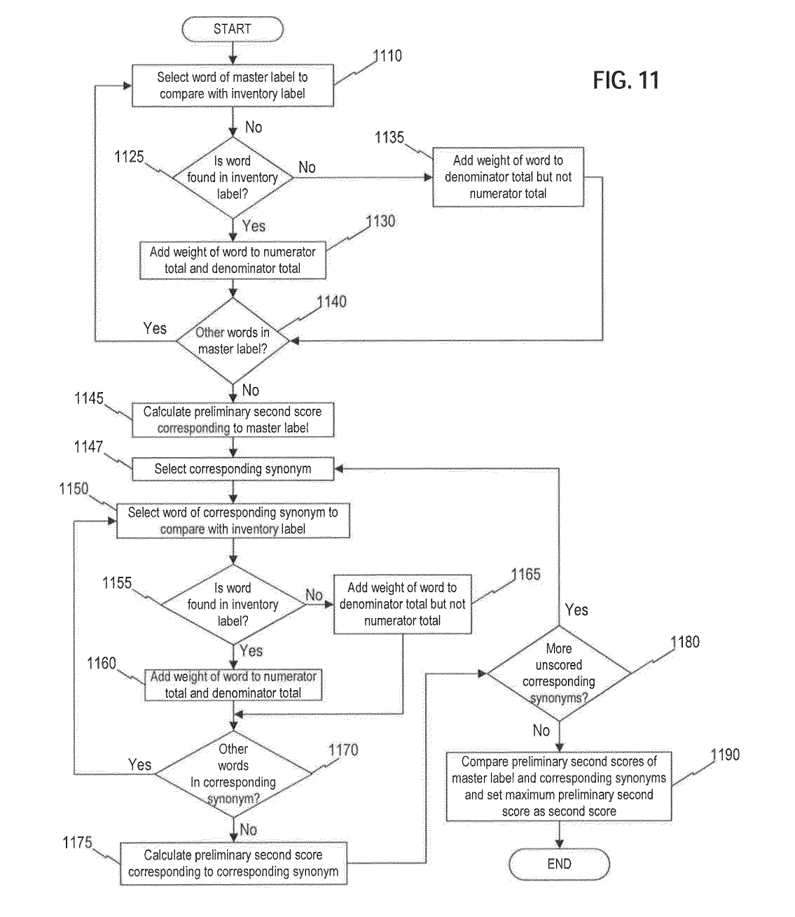

With continued reference back to FIG. 9, at step 915, inventory processor 220 may calculate a second score for the master label of the candidate plant that was given a first score at step 910. In one embodiment, the second score may be calculated according to an exemplary method 1100 depicted in FIG. 11.

At step 1110 of FIG. 11, inventory processor 220 may begin a process of comparing each word of the master label 571 of the candidate plant with the inventory label 550, by first selecting one of the words of the master label. Inventory processor 220 may determine whether the master label word is found in inventory label 550 (step 1125). If the master label word is found in inventory label 550 (step 1125: YES), inventory processor 220 may add the weight of the master label word to a numerator total N₂ and to a denominator total D₂ (step 1130). If the master label word is not found in the inventory label (step 1125: NO), inventory processor 220 may add the weight of the master label word to the denominator total D₂, but not to the numerator total N₂ (step 1135). Before determining whether the master label word is found in inventory label 550, inventory processor 220 may concatenate the words of the inventory label.

In one embodiment, the weight of the master label word that is added to the numerator total N₂ and/or the denominator total D₁ may be the count of letters in the master label word. For example, the weight of the word iceberg may be 7. In another embodiment, the weight of the master label word may be the count of letters in the master label word, up to a maximum. For example, the maximum may be set at 6. In which ease, the weight of the word iceberg is 6 (instead of 7). In yet another embodiment, the weight of the master label word may be pre-assigned based on statistical analysis of the significance that the particular word has in indicating a unique plant. Other schemes of weighting words may be used, according to the particularities of the system and situation.

As an example, “formosa azalea” may be the inventory label 550, and the candidate plant may be Rhododendron indica ‘formosa lavender’ (master label formosa lavender). Inventory processor 220 may determine that the master label word formosa is found in the inventory label “formosa azalea” (step 1125: YES). In the case where the weight of the word is the count of letters up to a maximum of 6, inventory processor 220 may then add the weight of formosa (e.g., 6) to both the numerator total N₂ and to the denominator total D₂ (step 135). For the master label word lavender, inventory processor 220 may determine that lavender is not found in inventory label “formosa azalea” (step 1125: NO). In the case where the weight of the word is the count of letters up to a maximum of 6, inventory processor 220 may add the weight of lavender (e.g., 6) to a denominator total D₂ but not to a numerator total N₂ (step 1130).

At step 1140, inventory processor 220 may determine whether there are more words in master label 571. If there are more words in master label 571 (step 1140: YES), inventory processor 220 may repeat steps 1110 to 1135 for the other master label words. If there are no more words in the master label 571 (step 1140: NO), the inventory processor 220 may calculate a preliminary second score that corresponds to the master label 571 (step 1145). Inventory processor 220 may calculate the preliminary second score corresponding to master label 571 by calculating the ratio of the numerator total N₂ to the denominator total D₂ (i.e., N₂/D₂).

For the example of inventory label “formosa azalea” and the candidate plant Rhododendron indica ‘formosa lavender’ (master label formosa lavender), inventory processor 220 may start with the master label word formosa (step 1110). Inventory processor 220 may determine that, the master label word formosa is found in the inventory label “formosa azalea” (step 1125: YES). As described above, inventory processor 220 may add a weight of the word formosa (e.g., 6) to a denominator total D₂ and a numerator total N₂ (step 1130), so that the denominator total D₂ has a value of 6 and the numerator total N₂ has a value of 6. At step 1140, inventory processor may determine that there are more words in the master label (step 1140: YES). Inventory processor may select the next word, lavender, in the master label (step 1110) and determine that lavender is not found in the inventory label “formosa azalea” (step 1125: NO). As described above, inventory processor 220 may add the weight of the word lavender (e.g., 6) to the denominator total D₂ hut not the numerator total N₂, so that both have a value of 6 (step 1135), Consequently, D₂ may have a value of 12 (the sum of 6 and 6, the weights of the words formosa and lavender, respectively) and N₂ may have a value of 6 (just the weight of formosa, since the weight of lavender does not get added to the numerator total N₂). With no more words in the master label formosa lavender (step 1140: NO), inventory processor 220 may divide N₂ (i.e., 6) by D₂ (i.e., 12), resulting in a preliminary second score for the master label formosa lavender of 0.5 (step 1145).

Inventory processor 220 may also calculate a preliminary score corresponding to respective corresponding synonyms 572 of the candidate plant by performing steps 1147 to 1180. At step 1147, inventory processor 220 may select one of the corresponding synonyms 572. At step 1150, inventory processor 220 may begin the process of comparing each word of the selected corresponding synonym 572, by selecting one of the words of corresponding synonym 572. At step 1155, inventory processor 220 may determine if the corresponding synonym word is found in the inventory label 550. If the corresponding synonym word is found in the inventory label 550 (step 1155: YES), inventory processor 220 may add a weight of the corresponding synonym word to a numerator total N₃ and to a denominator total D₃ (step 1160). If the corresponding synonym word is not found in inventory label 550 (step 1155: NO), inventory processor 220 may add the weight of the corresponding synonym word to the denominator total D₃, but not to the numerator total N₃ (step 1165). In determining whether the corresponding synonym word is found in inventory label 550, inventory processor 220 may concatenate inventory label 550 before comparing the corresponding synonym word with inventory label 550.

An example of steps 1155 to 1165 is described with respect to the inventory label “knock out rose” and the candidate plant Rosa ‘iceberg,’ with a corresponding synonym of knockout iceberg. Inventory processor 220 may select the word knockout from corresponding synonym knockout iceberg (step 1150) and determine whether the word knockout is found in inventory label knock out rose (step 1155). Inventory processor 220 may first concatenate the words of the inventory label before making this determination. Inventory processor 220 may determine that knockout is found in the inventory label (step 1155; YES), because the word knockout is found in the concatenated format of the label, i.e., “knockoutrose.” Inventory processor 220 may then add a weight of the word knockout (e.g., 6, when the weight is the count of letters up to a maximum of 6) to the numerator total N₄ and to the denominator total D₄ (step 1160).

If the synonym word is iceberg from corresponding synonym knockout iceberg (step 1150), inventory processor 220 may determine that the word iceberg is not found in the inventory label “knock out rose” (step 1155: NO). As a result, inventory processor 220 may add a weight of the word iceberg (e.g., 6) to the denominator total D₄ but not to the numerator total N₄ (step 1165).

At step 1170, inventory processor 220 may determine if there are more words in corresponding synonym 572. If there are more words in corresponding synonym 572 (step 1170: YES), inventory processor 220 may repeat steps 1150 to 1165 for the other words in the corresponding synonym 572. If there are no more words in the corresponding synonym (step 1170: NO), inventory processor 220 may calculate a preliminary second score that corresponds to the particular corresponding synonym 572 (step 1175). Inventory processor 220 may calculate the preliminary score for corresponding synonym 572 by calculating the ratio of the numerator total N₄ to the denominator total D₄ (i.e., N₄/D₄).

As an example, as discussed above for knockout iceberg, inventory processor 220 may add the weight of knockout to both the numerator total N₄ and the denominator total D₄, but the weight of iceberg to only the denominator total D₄. As result, the numerator total N₄ may be 6 and the denominator total D₄ may be 12. At step 1175, inventory processor 220 may calculate the preliminary second score for corresponding synonym knockout iceberg to be 0.5 (i.e., N₄/D₄=6/12).

At step 1180, inventory processor 220 may determine whether there are more corresponding synonyms 572 for the candidate plant. If there are more corresponding synonyms (step 1180: YES), inventory label may repeat steps 1147 to 1175 to calculate the preliminary second score for each of the respective corresponding synonyms 572. If there are no more corresponding synonyms (step 1180: NO), inventory processor 220 may proceed to calculate the second score for the master label of the candidate plant by comparing the preliminary second scores of the master label 571 and the corresponding synonyms 572, and setting the maximum preliminary second score as the second score (step 1190).

An example of a second scoring according to the full exemplary method 1100 is now described, for clarity and illustrative puiposes, using the example of the inventory label “knock out rose” and the candidate plant Rosa ‘iceberg’, which may have a master label of iceberg and corresponding synonyms of iceberg climbing, knockout iceberg, and white iceberg (as shown in Example 2 above).

Inventory processor 220 may select word iceberg from the master label to compare with the inventory label (step 1110). Inventory processor 220 may determine that iceberg does not indicate a parent class (step 1115: NO), and proceed to step 1125. Inventory processor 220 may determine that the master label word iceberg is not found in the inventory label “knock out rose” (step 1125: NO), and add the weight of iceberg (e.g., 6 In the exemplary case where the weight of the word is the count of letters up to a maximum count of 6) to a denominator total D₃ but not to a numerator total N₃ (step 1135).

At step 1140, inventory processor 220 may determine whether there are more words in the master label iceberg. Inventory processor 220 may determine there are no additional words in the master label iceberg (step 1140: NO), and proceed to calculate a preliminary second score corresponding to the master label (step 1145). Inventory processor 220 may calculate the preliminary score corresponding to the master label by dividing the numerator total N₃ (i.e. 0) by the denominator total D₃ (i.e., 6), resulting in a preliminary second score of 0.

At step 1147, inventory processor 220 may select a corresponding synonym of Rosa ‘iceberg’, for example, iceberg climbing. At step 1150, inventory processor 220 may select a word of iceberg climbing, for example iceberg. At step 1155, inventory processor 220 may determine whether iceberg is found in the inventory label “knock out rose.” Inventory processor 220 may determine that iceberg is not found In the inventory label “knock out rose” (step 1155: NO), and may add the weight of the word iceberg (i.e. 6) to the denominator total D₄ (which becomes 6), but not the numerator total N₄ (which stays at an initial value of 0), and proceeds to step 1170.

At step 1170, inventory processor 220 may determine whether there are other words in the corresponding synonym iceberg climbing, inventory processor 220 may determine there are additional words (step 1170: YES) and select one of these other words at step 1150, for example, climbing. At step 1155, inventory processor 220 may determine whether climbing is found in the inventory label “knock out rose.” Inventory processor 220 may determine that climbing Is not found in the inventory label “knock out rose” (step 1155: NO), and add the weight of the word climbing (i.e., 6) to the denominator total D₄ (which then becomes 12, from, the summation of the previous value of which was 6, and die weight of the word climbing), but not to the numerator total N₄ (which stays at 0).

Again at step 1170, inventory processor 220 may determine that there are no other words in the corresponding synonym iceberg climbing (step 1170: NO), and proceed to calculate the preliminary second score for the corresponding synonym iceberg climbing (step 1175). To calculate the preliminary second score for the corresponding synonym iceberg climbing. Inventory processor may divide the numerator total N₄ (i.e., 0) by the denominator total D₄ (i.e., 12), resulting in a preliminary score of 0, for iceberg climbing.

At step 1180, inventory processor 220 may determine whether there are more unscored corresponding synonyms for the candidate plant Rosa ‘iceberg’ (step 1180). Inventory processor 220 may determine that there are more unscored corresponding synonyms (step 1180: YES), and proceeds to repeat steps 1147 to 1180 for the other unscored corresponding synonyms.

At step 1147 again, inventory processor 220 may select the next unscored corresponding synonym of Rosa ‘iceberg’, e.g., knockout iceberg. At step 1150, inventory processor 220 may select a word from the corresponding synonym knockout iceberg, e.g., knockout. At step 1155, inventory processor 220 determines whether knockout is found in inventory label “knock out rose.” Because knockout is found in a concatenated format of the inventory label, i.e., “knockoutrose” (step 115: YES), inventory processor 220 may proceed to step 1160 and adds the weight of the word knockout (e.g. 6) to the numerator total N₄ (which is reset, to 0 for each corresponding synonym being scored) and to the denominator total D₄ (which is also reset to 0 for each corresponding synonym being scored). As a result, the numerator total N₄ has a value of 6 and the denominator total D₄ has a value of 6.

At step 1170, inventory processor 220 may determine whether there are other words in the corresponding synonym knockout iceberg which are not yet scored. Inventory processor 220 may determine that there are other words in the corresponding synonym knockout iceberg (step 1175: YES), and proceed to step 1150 to select another word of the corresponding synonym knockout iceberg (i.e., iceberg). At step 1155, inventory processor 220 may determine that the word iceberg is not in the inventory label “knock out rose” (step 1155: NO), and proceed to step 1165. At step 1165, inventory processor 220 may add the weight of the word iceberg (e.g., 6) to the denominator total D₄ (resulting in D₄ with a value of 12), but not to the numerator total N₄ (which results in N₄ keeping a value of 6).

Again at step 1170, inventory processor 220 may determine that there are no other words in corresponding synonym knockout iceberg (step 1170: NO). At step 1175, inventory processor 220 may determine the preliminary second score for the corresponding synonym knockout iceberg, by dividing the numerator total N₄ (i.e., 6) by the denominator total D₄ (i.e., 12), resulting in a preliminary second score of 0.5.

At step 1180, inventory processor 220 may determine that there are more unscored corresponding synonyms for candidate plant Rosa ‘iceberg’, i. e. white iceberg. Inventory processor 220 may then performs steps 1147 to 1175 for corresponding synonym white iceberg, which will not be described in detail as the process is similar to that for iceberg climbing and knockout iceberg, as described above. At step 1175, inventory processor 220 may calculate the preliminary second score of white iceberg to be 0.

At step 11 80, inventory processor 220 determines that there are no more unseored corresponding synonyms (step 1180: NO). At step 1190, inventory processor 220 compares the preliminary scores for the master label iceberg, and the corresponding synonyms iceberg climbing, knockout iceberg, and white iceberg (which are 0, 0, 0.5, and 0, respectively), and sets the maximum preliminary second score (i.e., 0.5) as the second score for master label of Rosa ‘iceberg’.

In one embodiment, because the maximum second preliminary score is set as the second score for the master label, if one of the maximum second preliminary scores is calculated as 1.0 (the maximum possible value for a score), inventory processor 220 may cease calculating the remaining second preliminary scores, if any are left that are yet to be calculated, since it is already determined that the second score of 1.0 (the maximum possible score) will be assigned to the master label.

With continued reference back to FIG. 9, after calculating a first score (at step 910) and a second score (at step 915) for a master label of a candidate plant, inventory processor 220 may set the minimum of the first score and the second score as the master score of the master label (step 920).

For example, the first score of the master label of Rosa ‘iceberg’ was calculated to be 1.0, at step 910, and the second score of the master label of Rosa ‘iceberg’ was calculated to be 0.5, at step 915. At step 920, inventory processor 220 may set the minimum score (i.e., the second score of 0.5) as the master score for Rosa ‘iceberg’.

At step 925, inventory processor 220 may determine whether all master labels of the candidate plants have been scored. If there are candidate plants that have not been scored (step 925: NO), inventory processor may repeat steps 910 to 920 for the other candidate plants.

For example, at step 925, inventory processor 220 may determine whether all candidate plants for “knock out rose,” which include Rosa ‘iceberg’, Rosa ‘livin’ easy’. Rosa ‘meigalpio’. Rosa ‘meijocos’, Rosa ‘meitroni’, Rosa ‘outta the blue’, Rosa ‘radcarn’, Rosa ‘radcon’, Rosa ‘radcor’, Rosa ‘radrazz’, Rosa ‘radsunny’, Rosa ‘radtko’, Rosa ‘radtkopink’, Rosa ‘radwhite’, Rosa ‘radyod’, and Rosa ‘sprothrive’, have been scored. Inventory processor 220 may process any candidate plants and their master labels that have not been scored by repeating steps 910 and 920, which may include exemplary methods 1000 and 1100.

If all candidate plants have been scored with a respective master score (step 925: YES), inventory processor may determine which candidate plant has the highest master score (step 930), At step 935, inventory processor 220 may determine whether the highest master score is greater than a predetermined threshold. If the highest master score is greater than a predetermined threshold (step 935: YES), inventory processor 220 may determine whether the highest master score Is greater than the next highest master score by a predetermined threshold (step 940). If the highest master score is greater than the next highest master score by a predetermined threshold (step 940: YES), inventory processor 220 may determine that the candidate plant (and its master label) with the highest master score matches the inventory label (step 955). If inventory processor 220 determines that the highest master score is not greater than a predetermined threshold (step 930: NO) or is not greater than the next highest master score by a predetermined threshold (step 940: NO), inventory processor 220 may determine a match for the inventory label using an alternative method or otherwise output no result or an error output or no result output (step 950).

In one embodiment, if the score does not meet certain predetermined requirements, e.g., at step 935 and/or step 940, inventory processor 220 may determine a match for the inventory label using an alternative method at step 950 that is based on other criteria. For example, inventory processor 220 may generate an edit score at step 950. The edit score may be based on an edit distance from the inventory label to master labels or corresponding labels. An edit distance may be the number of elemental operations on spaces or characters in the inventory label that results in the inventory label matching a master label or corresponding label. For example, the word fromoas and the word formosa may have an edit distance of 2, since two elemental operations (e.g., switching of the positions of s and a, and switching of the positions of r and o) must be performed to make fromoas match formosa. In one example, the edit score may be one minus the edit distance, divided by the number of letters in the inventory label. A candidate plant's score may be the maximum of the master score as calculated at step 920 and the edit score,

With continued reference to FIG. 4, at step 460, inventory processor 220 may create a record in provider database 130, which associates the provider of the inventory from which the inventory label has been matched with a master label, at step 955. In one embodiment, inventory processor 220 may generate a new database record with this association. In another embodiment, inventory processor 220 may update an already existing database record with this association. Furthermore, in one embodiment, the database record may also associate other information extracted from the inventory (e.g., product specifications) with the matching master label and the provider.

The disclosed systems and methods disclosed may be used to populate a provider database with inventory data associated with the providers stored in the database. Such a database, along with other system components, may then be used to provide recommendations of providers to product buyers. In one exemplary embodiment, in which the products are plants, some of the disclosed systems and methods address the complex problem of receiving inventories from different providers that identify the same product with different names, and assigning a common naming convention for the same product provided by the different-providers. Such systems and methods are not limited to applications related to plant products, but are applicable to other situations in which products are identified by a plurality of possible names, but a common, consistent identification of the products is desired.

In addition to the methods disclosed above, inventory processor 220 may perform various other methods. For example, inventory processor 220 may include a score bias for candidate plants that have a plant patent number that matches a plant patent number that was initially associated with the inventory label in the input inventory. That is, a master score may be increased by a certain amount if the plant patent numbers match. In yet another example, if inventory processor 220 does not find any candidate genus (while performing die methods of FIG. 4 and FIG. 7), inventory processor 220 may determine a list of candidate plants based on the plants that have a master label or corresponding synonym that, matches the inventory label. In one embodiment, this matching may Include the removal of spaces or punctuation before comparison between the inventory label and the corresponding synonym or master label.

Below is exemplary pseudocode showing one implementation of exemplary disclosed methods.

For each line of the inventory:

Special line handling:

Look for “block” genus
Look for lines that should be skipped
Convert raw line to fields (e.g., name, size, specs, comments,
etc)
Extract plant patent, size, specs, price, etc from “name” field
Sanitize name field (remove non-text characters) to generate
inventory label

Generate list of candidate plants:

Calculate candidate_genus_list from raw text:

Candidate_genus_list = new list
For each word in inventory label:

```
Append to candidate_genus_list the genus of each
plant whose
  master label or corresponding synonym matches
  the given word
```

For each pair of words in raw text:

```
Append to candidate_genus_list the genus of each
plant whose
  master label or corresponding synonym matches
  the given word
  pair
```

Return candidate_genus_list

```
If candidate_genus_list is empty, then return the list of plants
which have a master
  label or corresponding synonym that exactly matches the
  inventory label
Filter plants within each genus in candidate_genus_list
for those plants that “match”
  the inventory label:
```

Candidate_plant_list = new list
For each genus in candidate_genus_list:

For each plant in genus:

```
Append plant to candidate_plant_list if each
word in
  inventory label is found in the master label or
  corresponding synonym of the plant
```

Return plant_list

Calculate score_list. For each plant in candidate_plant_list,
calculate plant score:

Calculate first score:

Numerator = 0
Denominator = 0
For each word in inventory label:

```
Word_weight = func(word)
Plant-specific names = {master label,
corresponding
  synonyms}
Plant-parent names = {master label of plant's
parents,
  corresponding synonyms of plant's parents}
If word in plant-specific names: numerator +=
word_weight
```

denominator += word_weight

Else if word in plant-parent names: do nothing
Else: denominator += word_weight

Return first_score = numerator / denominator

Calculate second score:

max_second_score = 0
Master label and each corresponding synonyms is
a candidate_name
For each candidate_name

numerator = 0
denominator = 0
For each word in candidate_name:

word_weight = func(word)
denominator += word_weight
if word in inventory label: numerator +=
word_weight

Return preliminary_second_score = numerator /
denominator

Return max_second_score = max of all
preliminary_second_scores

Append to score_list: score = min(first_score,
second_score)

Special score handling:

Calculate per-plant edit score:

If max of score_list > threshold, do nothing
For each plant, plant_score in plant_list, score_list

plant_score = max(plant_score, edit_score)

```
If the input line text came with a plant patent number,
and a plant in
  plant_list matches that patent, increase plant_score
  of that plant
If no genus was found from the inventory label, for
each score: score
  = a * score, where a < 1.0
```

Disambiguate scores when more than one plant_score =
1.0

max_score = max(score_list)
score_ratio = highest score − 2^{nd} highest score
If max_score > threshold and score_ratio > threshold:

return plant with highest score

else: return nil

It will be apparent to those skilled in the art that various modifications and variations can be made to the disclosed systems and methods. Various system components can be found on the same device or hardware or on different devices or hardware, or a combination. Various system components can also be found in different relationships with each other than shown in the figures. Various disclosed method steps may be performed in parallel, in serial, and in different order than as shown and discussed in the exemplary embodiments disclosed, as would be easily recognized by a person of ordinary skill in the art. For example, in method 600, steps 610 and/or 620 may be optional. As another example, in method 800, steps 820 and 830 may be switched in order, or performed in parallel. As yet another example, in method 900, steps 910 and 920 may be switched in order, or performed in parallel, or the scoring of multiple candidate plants may be performed in parallel. These examples are exemplary only, and in no way meant to be an exhaustive set of steps that may be performed in serial, parallel, or alternative orders. In addition, various hardware components and/or method steps may be omitted. For example, the master score may be based on only the calculation of one of the first score or the second score, the determination of matching candidate plant may be based on whichever has the highest score without comparing it to a predetermined threshold, the inventory processor may not perform genus block identification, etc. Furthermore, various embodiments can be performed in various alternative combinations compared to the combinations disclosed. No examples are meant to be limiting or exhaustive, only exemplary and for illustrative purposes.

Other embodiments will be apparent to those skilled in the art from consideration of the specification and practice of the disclosed machine implement control system. For example, disclosed inventory systems and provider recommendation systems may be utilized for other types of products. It is intended that the specification and examples be considered as exemplary only, with a true scope being indicated by the following claims and their equivalents.

What is claimed is:

1. A computer system for processing an inventory of plants of a provider into a database, comprising:
an input interface, which receives the inventory, wherein one or more plants in the inventory are associated with an inventory label;
a storage device, which stores a master list of plants, wherein each plant in the master list is associated with a master label; and
an inventory processor, implemented by one or more computing processors, which matches a selected plant in the inventory to a plant in the master list by;
identifying the inventory label of the selected plant;
identifying at least one candidate genus based on the inventory label of the selected plant;
determining candidate plants by identifying plants in the master list that are associated with the at least one candidate genus:
scoring, each master label of the candidate plants with a master score,
wherein the scoring of each master label comprises;
determining a first score for the master label based on a count of letters In the inventory label,
determining a second score for the master label, and
selecting a minimum of the first score and the second score as the master score; and
selecting a plant having a highest master score from the candidate plants as a matched plant; and
creating a record in the database associating the matched plant with the provider,

2. The computer system of claim 1, wherein the inventory processor determines the first score for the master label by comparing each word in the inventory label with the master label and corresponding synonyms of the master label.

3. The computer system of claim 2, wherein the inventory processor, when determining the first score for the master label, ignores a word in the inventory label if the word is identified as indicating a parent class of the master label.

4. The computer system of claim 1, wherein the inventory processor determines the first score by:
adding a weight of a word in the inventory label to both a first numerator total and a first denominator total when the word in the inventory label is found in the master label or corresponding synonyms;
adding the weight of the word in the inventory label to the first denominator total but not the first numerator total when the word in the inventory label is not found In the master label or corresponding synonyms; and
calculating the first score for the master label by dividing the first numerator total by the first denominator total.

5. The computer system of claim 4, wherein the weight of the word is equivalent to a count of letters in the word.

6. The system of claim 5, wherein:
the weight of the word is the count of letters in the word up to a predetermined maximum length,

7. The computer system of claim I, wherein the inventory processor determines the second score by:
calculating a respective preliminary second score for each of the master label and corresponding synonyms, by:
comparing each word in the master label or corresponding synonym with the inventory label;
adding a weight of the word to a second numerator total and a second denominator total when the word Is found in the inventory label;
adding the weight of the word to the second denominator total but not the second numerator total when the word is not found in the inventory label; and
dividing the second numerator total by the second denominator total; and
selecting, from the preliminary second scores of the master label and each corresponding synonym, a maximum preliminary second score as the second score.

8. The computer system of claim 7, wherein the weight of the word is equivalent to the count of letters in the word.

9. The system of claim 8, wherein:
the weight of the word is equivalent to the count of letters in the word up to a predetermined maximum length.

10. The system of claim 1, further comprising:
a parser for parsing the inventory received via the input interface to identify the inventory label of the selected plant, wherein the parser:
identifies text that correspond to a genus; and
removes non-alphanumeric text from the identified inventory label.

11. The system of claim 1, wherein the inventory processor identifies the at least one candidate genus by:
identifying a genus of each plant in the master list whose master label or corresponding synonym of the master label matches at least one word in the inventory label.

12. The system of claim 11, wherein the inventory processor identifies the at least one candidate genus by:
identifying a genus of each plant in the master list whose master label or corresponding synonym of the master label matches at least a pair of words in the inventory label.

13. The system of claim 1, wherein the inventory processor further determines the candidate plants by:
comparing the master label of each plant identified as being in the genus to the inventory label; and
filtering out the candidate plants for which no word in the inventory label is found in the master label of the respective candidate plants.

14. The system of claim 1, wherein selecting the matched plant further comprises:
determining that the master score of the matched plant is greater than a predetermined threshold.

15. The system of claim 1, wherein selecting the matched plant further comprises:
determining that the master score of the matched plant is greater than a next highest score by a predetermined threshold.

16. The system of claim 3, wherein:
the parent class, used to ignore the word in the inventory label if identified as indicating the parent class, is one of genus, species, variety, or cultivar.

17. The system of claim 5, wherein:
a parser identifies the plant patent number associated with the selected plant in the inventory; and
the inventory processor includes a bias to the master score of a master label that is associated with the same plant patent number as the selected plant in the inventory,

18. A computer system for determining recommended providers for an order of plants, comprising;
an order input interface, which receives the order including parameters related to the order;
a database, which stores a set of candidate providers and corresponding inventories of plants of the candidate providers;
an inventory system, which processes an inventory of plants of a provider into the database; and
a linear programming solver for choosing the recommended providers from the set of candidate providers based on the parameters included in the order and the inventories of the candidate providers:
wherein the inventory system comprises:
an inventory input interface, which receives the inventory, wherein one or more plants in the inventory are associated with an inventory label;
a storage device, which stores a master list of plants, wherein each plant in the master list is associated with a master label; and
an inventory processor, implemented by one or more computing processors, which matches a selected plant in the inventory to a plant in the master list by:
identifying the inventory label of the selected plant;
identifying at least one germs based on the inventory label of the selected plant;
determining candidate plants by identifying plants in the master list that are in the identified genus;
scoring each master label of the candidate plants with a master score based on comparing the master label with the inventory label, wherein the scoring uses a count of letters in the inventory label;
selecting a matched plant from the candidate plants that has a master label with a highest score; and
creating a record in the database associating the matched plant with the provider.

19. A computer-implemented method for processing an inventory of a provider into a database, performed by one or more computing processors, comprising:
receiving the inventory, wherein one or more plants in the inventory are associated with an inventory label;
storing, in a storage device, a master list of plant, wherein each plant in the master list is associated with a master label;
matching, by the one or more computing processors, a selected plant in the inventory to a plant in the master list, wherein the matching comprises:
identifying the inventory label of the selected plant;
identifying at least one candidate genus based on the inventory label of the selected plant;
determining candidate plants by identifying plants in the master list that are associated with the identified genus;
scoring each master label of the candidate plants with a master score,
wherein the scoring of each master label comprises:
determining a first score for the master label,
determining a second score for the master label, and
selecting a minim urn of the first score and the second score as the master score; and
selecting a plant having a highest master score from the candidate plants as a matched plant; and
creating a record in the database associating the matched plant with the provider.

20. A computer system for processing an inventory of products of a provider into a database, comprising:
an input interface, which receives the inventory, wherein one or more products in the inventory are associated with an inventory label:
a storage device, which stores a master list of products, wherein each product in the master list is associated with a master label; and
an inventory processor, implemented by one or more computing processors, which matches a selected product in the inventory to a plant in the master list by:
identifying the inventory label of the selected product;
identifying at least one candidate class based on the inventory label of the selected product;
determining candidate products by identifying products in the master list that are associated with the at least one candidate class;
scoring each master label of the candidate products with a master score,
wherein the scoring of each master label comprises:
determining a first score for the master label based on a count of letters in the inventory label,
determining a second score for the master label, and
selecting a minimum of the first score and the second score as the master score; and
selecting a product having a highest master score from the candidate products as a matched product: and
creating a record in the database associating the matched product with the provider.

21. The method of claim 19, wherein the first score is determined by:
adding a weight of a word in the inventory label to both a first numerator total and a first denominator total when the word in the inventory label is found in the master label or corresponding synonyms;
adding the weight of the word in the inventory label to the first denominator total but not the first numerator total when the word in the inventory label is not found in the master label or corresponding synonyms; and
calculating the first score for the master label by dividing the first numerator total by the first denominator total,
wherein the weight of the word is based on statistical analysis of accumulated data.
